(19) United States
(12) Patent Application Publication
(10) Pub. No.: US 2011/0196620 A1
(43) Pub. Date: Aug. 11, 2011

(54) OPPORTUNITY SECTOR ANALYSIS TOOL

(76) Inventors: Johannes Lampe, Berlin (DE); Andreas Konieczny, Deisenhofen (DE)

(21) Appl. No.: 13/057,859

(22) PCT Filed: Dec. 1, 2008
(86) PCT No.: PCT/EP08/10183

§ 371 Date: Apr. 21, 2011

(30) Foreign Application Priority Data
Aug. 6, 2008 (EP) PCT/EP2008/006480

(51) Int. Cl. G06F 19/00

(52) U.S. Cl. 702/27

(57) ABSTRACT

The present invention refers to a method for evaluating, comparing and selecting entities over a broad variety of technical fields. Preferably, the entities are pharmaceutical drugs.

### RELATED APPLICATIONS

The current patent application is based on the European Patent Application Nr. 07 015 407.5 and international application PCT/EP2008/006480. Therefore, all information provided in the European Patent Application Nr. 07 015 407.5 and PCT/EP2008/006480 also applies for the presented patent application.

In the first aspect of the applications a method is provided for comparing and evaluating candidates in a class of compounds. An addition is provided in this document (Value Adjusted Evidence Level).

In the second aspect of the invention provides a method for obtaining a ranking of compounds suitable for use in an intended pharmaceutical application.

Terms used in the present application are—unless not defined differently—defined as in PCT/EP2008/006480.

### FIELD OF THE INVENTION

The present invention refers to a method for evaluating, comparing and selecting entities over a broad variety of technical fields. Preferably, the entities are pharmaceutical drugs.

### BACKGROUND OF THE INVENTION

The presented patent application can be used to better identify the optimal combination of characteristics of compounds or entities for a particular market need.

Before being able to compare and identify optimal characteristics the establishment of a universal measure or scale has to be done. This is performed by the introduction of the Evidence Level (EL) or Comparator Adjusted Evidence Level (CA-EL) as described in the European Patent Application Nr. 07 015 407.5 and international application PCT/EP2008/006480 or by other measures. In the present patent application an additional method is introduced, the Value Adjusted Evidence Level (VA-EL). This is being followed by display of a practical (real world) example as it is currently used as a proof of concept.

This is followed by a description of a methodology allowing to put the results obtained by above methods (calculation of the EL, CA-EL, VA-EL) into context of decision situation (e.g. how to position a product in a given market situation).

Very often product profiles have to balance an optimal combination of benefits and risks to be successful in future markets. For example increased benefits of a pharmaceutical compound are very often linked to increased risks, or higher interests for a saving deposit are linked to a higher risk to lose the saving deposit. On the other hand, for a more secure saving deposit fewer interests are provided. Therefore, the identification of the optimal benefit/risk ratio is crucial. Besides others the identification of an optimal benefit/risk ratio is enabled by the methods of the presented patent application.

An important market where the optimal combination of different characteristics plays a main role is the pharmaceutical market. A typical problem in research and development of a compound is to find the optimal benefit/risk ratio in context of the targeted market: If a compound is efficacious, i.e. if it has a positive biological impact on an organism, these positive effects typically are accompanied by undesired sequels, i.e. side effects. Normally efficacy and side effects stand to each other in a proportional relationship: With increased efficacy, side effects (safety) quantitatively and qualitatively increase as well.

If number and severity of side effects are acceptable for the treatment of a disease depends on several factors:
(1) Degree of unmet medical need (e.g. availability of treatment alternatives).
(2) Seriousness and severity of the disease (e.g. for the treatment of cancer other side effects are acceptable than for the treatment of flu).

The presented patent application is suited to identify the optimal side effect (“safety”)/efficiency (“efficacy”) ratio of a compound. Additional aspects including a certain dosage or mode of application in context of a given indication and market situation may be included in the assessment.

Furthermore, the present invention may help to extrapolate (“translate”) the data obtained in animal models into the situation in man: For example, the results obtained in toxicological and efficacy models in animals may be translated into safety/efficacy in man.

A given market situation is assessed based on other entities characterizing compounds which are already in the respective market. Based on the known risk/benefit ratios of those established entities (e.g. approved drugs) an “Opportunity Sector Analysis” may be performed.

Additional analysis may be performed for subgroups of entities, e.g. by different development phase, patient sub-groups (timelines, costs, revenue, patient sub-groups), safety sub-groups (e.g. infections, immunosuppression), efficacy sub-groups (e.g. clinical endpoints, surrogate markers).

Additionally, specific aspects of a compound may be analysed like the target(s) bound by the compound, involved biological pathways or the mode of action of the compound.

Alternatively, a given market situation may be assessed based on a so-called “realistic corridor analysis”. The “realistic corridor analysis” is based on a regression analysis including characteristics of a set or sub-set of compounds or entities, e.g. side effects and efficacy of compounds in a certain disease. This leads to a calculated value describing the interrelations of two or more characteristics (e.g. side effects and efficacy) for the entire population (e.g. the disease in which the compounds are used).

### SUMMARY OF THE INVENTION

One object underlying the present invention is to overcome the disadvantages of these prior art methods and provide an improved means for comparing and selecting pharmaceutical compounds or drugs.

Another object underlying the present invention is to increase “safety” and/or “efficacy” of pharmaceutical drug candidates.

Another objective underlying the present invention is to increase the overall success of a pharmaceutical drug candidate related to all scientific aspects. Scientific aspects may cover pharmacokinetics (the effect of the body on the compound), pharmacodynamics (e.g. the effect of the drug on the body), toxicological, physical or chemical properties of a compound.

Another object underlying the present invention is to minimize costs in pharmaceutical drug discovery and development.

Another object underlying the present invention is to provide a universal means which assists in comparing and selecting most promising entities from a collective of candidate entities.

Another object underlying the present invention is to provide a universal means which accerates comparing and selecting most promising entities from a collective of candidate entities.

These objects are solved by the methods/uses of the present invention as follows:

In a first aspect of the present invention the embodiments below are provided.

1. A method for comparing and evaluating one or more candidate compounds the method comprising:
a) Constructing and displaying a Cartesian xy-coordinate-system,
b) Accessing a dataset of a number of compounds stored in a dataset, which dataset comprises the class of compounds and two values x and y assigned to each compound, wherein x is a first Evidence Level, and y is a second Evidence Level,
c) Using the data of b) for placing data points into the Cartesian coordinate-system, wherein for each compound of the dataset and its assigned x and y values of the database a point P(x/y) is obtained and displayed;
d) Using the points P obtained in c) in order to determine and display
d1) the point with the maximum x value and the point with the minimum x value,
d2) the point with the maximum y value and the point with the minimum y value, and to draw two straight lines in parallel to the X-axis through the points obtained in d1) and two straight lines in parallel to the Y-axis through the points obtained in d1), thereby constructing a rectangle, the so called “promising rectangle”;
e) Using the points P obtained in c) in order to determine and display the “sweet spot”, that is the point with the median x and median y value over all compounds obtained in c)
f) Using the “sweet spot” obtained in e) and the points P obtained in c) in order to determine and display the “sweet spot circle” in the coordinate-system, that is the circle with the centre “sweet spot” and the radius, which is the maximum distance between the “sweet spot” one of the points P with the highest x or the highest y value. Optionally using the points P obtained in c), the “promising rectangle” obtained in d), the “sweet spot” obtained in e), and the “sweet spot circle” obtained in f) in order to determine and display the “sweet spot circle sector” in the coordinate-system, that is the area obtained by determining the sector of the “sweet spot circle”, which is limited by two straight lines drawn through the “sweet spot” and the point of the compound with the maximum x value and the point of the compound with the maximum y value and by limiting the obtained sector to the area which lies within the “promising rectangle”.
g) Using the points P obtained in c), the “promising rectangle” obtained in d), the “sweet spot” obtained in e), and the “sweet spot circle” obtained in f) in order to determine and display the “opportunity sector” in the coordinate-system, that is the area obtained by determining the sector of the “sweet spot circle”, which is limited by two straight lines drawn through the “sweet spot” and two points P so that the obtained sector does not comprise more than two points P and the sector is intersected by a straight line drawn through the “sweet spot” and a point M (1;1) with the Coordinates x=y=1 and is the sector closest to M(1;1) alternatively M may be a point in the quadrate M(1;1)N(0,8;0,8)O(1;0,8)P(0,8;1)
h) Placing the data points for one or more candidate compounds into the coordinate-system,
i) Evaluating the one or more candidate compounds by identifying the position of their data points relative to “promising rectangle”, “sweet spot circle” and/or “opportunity sector” in the coordinate-system.

The evidence level may be the evidence level EL or the comparator adjusted evidence level CA-EL or the Value Adjusted Evidence Level VA-EL.

2. A method for comparing and evaluating a candidate in a class of compounds or entities, the method comprising:
a) Placing a data point for a number of compounds into a Cartesian coordinate-system xy, wherein x and y are Evidence Levels, each data point represents a point P(xₚ/yₚ) in the coordinate system, and each xₚ and each yₚ is an Evidence Level of a compound P of the number of compounds;
b) Defining a “promising rectangle in the coordinate-system;
c) Defining a “sweet spot” in the coordinate-system;
d) Defining a “sweet spot circle” in the coordinate-system;
e) Optionally defining a “sweet spot circle sector” in the coordinate-system;
f) Defining an “opportunity sector” in the coordinate-system;
g) Placing the data point for the candidate compound into the coordinate-system,
h) Evaluate the candidate compound by identifying its position relative to “promising rectangle”, “sweet spot circle” and/or “opportunity sector” in the coordinate-system.
i) Optionally performing the “realistic corridor analysis” by drawing a regression curve drawing two parallels to the regression curve and evaluating the compounds between the limits of the two parallels and the limits of the “promising quadrate”.

The evidence level may be the evidence level EL or the comparator adjusted evidence level CA-EL or the Value Adjusted Evidence Level VA-EL.

3. The method of 1 or 2, comprising
j) Localizing a candidate compound's data point within the “opportunity sector” and selecting this compound.

4. Use of the method of 1, 2 or 3 for identifying and/or providing a candidate compound suitable for treating a patient.

5. The method of 1 or 2, comprising
j) Localizing a candidate compound's data point outside the “promising rectangle” and selecting this compound.

6. Use of the method of 5 for identifying a candidate compound not suitable for treating a patient.

7. The method of 1 or 2, comprising
j) Localizing a candidate compound's data point outside the “sweet spot circle sector” and selecting this compound.

8. Use of the method of 7 for identifying a candidate compound not suitable for further development in a given indication compared to launched compounds in this indication.

9. The method of 1 or 2, comprising
j) Localizing a candidate compound's data point inside the promising rectangle but outside the “sweet spot circle sector” and selecting this compound.

10. Use of the method of 9 for identifying a candidate compound not suitable for further development in a given indication compared to launched compounds in this indication, but a compound that may be made subject to further research.

11. The method of 1 or 2, comprising
j) Localizing a candidate compound's data point inside the promising rectangle and inside the sweet spot circle sector and selecting this compound.

12. Use of the method 1 or 2 for identifying and providing a candidate compound suitable for further development in the given indication taking the market situation in this indication into consideration.

13. Use of the method of 1, 2 or 11, for determining the optimal dosage for an indication taking the market situation in this indication into consideration, wherein the selected candidate compound is the compound with optimal dosage and the class of compounds set forth in 1a) comprises compounds which are the same as the candiadate compound but in different concentrations.

14. Use of the method of 1 or 2 for comparing and evaluating different dosages of a compound, wherein the selected candidate compound is a compound with a particular dosage and the class of compounds set forth in 1a) comprises compounds which are the same as the candiadate compound but in different concentrations.

15. Use of the method of 1 or 2 for comparing and evaluating different administration modes of a compound such as administration via infusion, intramuscular administration, oral administration, wherein the selected candidate compound is a compound with a particular mode of administration and the class of compounds set forth in 1a) comprises compounds which are the same as the candiadate compound but in different modes of administration.

16. Use of the method of 1 or 2 for the providing of an optimal biomarker, wherein the class of compounds set forth in 1a) is a number of different biomarkers for a particular indication.

17. A system for performing the method of present 1 or 2.

18. A data carrier comprising a programme for performing the method of 1.

19. Use of the determination of an opportunity sector for identifying
a. a compound suitable for the further development of a given medical indication,
b. an optimal dosage for a given compound,
c. the best mode of administration of a given compound,
d. the selection of the best indication of a given compound, or
e. the most promising compound in animal experiments to be further developed in clinical trials

20. The method of 3, comprising preparing the candidate compound selected in 3.

21. Use of the compound selected in 3 for preparing a pharmaceutical composition

22. Compound selected in 3 for pharmaceutical use.

All of the claimed embodiments are not limited to pharmaceutical compounds or compounds only, but include entities in place of compounds as well. Such entities may be indications or concentrations of compounds or application modes of compounds among others.

| Perform Steps of the Method of the | |
|---|---|
| Present Invention | Technical Purpose |
| Localization of a compound outside of the | Compound probably not suited for further |
| “promising rectangle” | development in the given medical indication |
| | (when compared to launched compounds in |
| | this indication) |
| Localization of a compound inside the | Compound may be suited for further |
| “promising rectangle” but outside of a | development in the given medical indication |
| “sweet spot circle sector” | (particular market situation in this indication |
| | not considered) |
| Localization of compound inside the | Compound may be suited for further |
| “promising rectangle” and inside of a “sweet | development in the given indication |
| spot circle sector” | (particular market situation in this indication |
| | considered) |
| Comparison of different dosages | Identification of the optimal dosage for a |
| | given compound |
| Evaluation of different compound | Assessing the best mode of administration |
| subgroups, e.g. different application forms | (“compound subgroups”) |
| (e.g. infusion, versus intramuscular, versus | |
| orally), biologicals versus small molecules, | |
| . . . | |
| Comparison of a particular compound with | Selection of best indication for a given |
| competitor compounds across indications | compound |
| Comparison of a particular compound with | Selection of the best compound from animal |
| competitor compounds across development | experiments (“prediction” of the human |
| phases (e.g. animal experiments with human | situation from animal data). |
| data) | |
| Comparison of a particular compound in | Selection of the compound with which the |
| combination with other compounds | compound under evaluation can be |
| | combined with, i.e. selection of optimal |
| | partner compound for combination therapies |
| Comparison of different biomarkers for a | Selection of the optimal biomarker (or |
| particular condition (e.g. indication) | alternatively endpoint) |
| regarding specificity and sensitivity with | |
| competitor biomarkers (or alternatively | |
| endpoint) | |
| Comparison of a treatment (e.g. surgery) | Selection of the optimal treatment for a |
| with other treatments (e.g. pharmaceutical | given condition |
| treatment) for a certain indication | |
| Comparison of the degree of a certain side | Selection of the compound/dosage which |
| effect (e.g. number or severity of an | has marginal numbers/severity of |
| infection) across compounds/doses | infections in combination with best |
| depending on the degree of efficacy | treatment effects |
| Detailed analysis of certain competitor | Identification of direct competitors and |
| compound features (e.g. subgroups of | support of the marketing strategy |
| endpoints or side-effects) | |
| Total revenue/return on investment versus | Identification of factors responsible for |
| safety or efficacy evidence level (including | highest revenue/return on investment |
| analysis of certain safety and efficacy | |
| subgroups) | |
| Phase dependent and independent | Identification of factors responsible for |
| comparison of Probability of Realization | success or failure of a compound in |
| (e.g. probability of successful study phase) | development |
| versus safety/efficacy evidence level | |
| (including analysis of certain safety and | |
| efficacy subgroups) | |
| “Probability of an endpoint to demonstrate | Identification of endpoints indicative for |
| superiority/non-inferiority” versus | successful approval by the authorities |
| probability that an endpoint was | |
| successfully used in a trial leading to | |
| approval | |

In the second aspect of the invention provides a method for obtaining a ranking of compounds suitable for use in an intended pharmaceutical application.

The method comprises the steps a) to l) below:
a) collecting data from candidates of compounds tested in different studies, which data show a variety of endpoints determined for at least two of the compounds in one study
b) comparing each compound in a study with each other compound along the data of all endpoints determined
c) obtaining for each endpoint of a study an absolute ranking, AR, of the compounds
d) determining the relative rank, RR, for each compound of one study in comparison to each other compound along each endpoint in the same study, wherein for each compound RR=−1 in case of inferiority, RR=0 in case of equality, and RR=1 in case of superiority as compared to the other compound in the same study
e) determining the Evidence Points” (EP) for each compound of one study, wherein for each compound the superior RR values, RR=1, over all endpoints are summed up to obtain the EP, which is the sum of all superior RRs for a compound in a study.

This is performed for each study separately.
f) determining the “Evidence Level” (EL) for each compound of a study, wherein for each compound in a study, its EP (i.e. the number of superior endpoints of a compound) is divided by Factor A, which A is the product of the number of endpoints multiplied with the difference of the number of compounds included in the study minus 1
g) determining the “overall EL value (ELₛᵤₘ)” for each compound over all studies, wherein in order to obtain the ELₛᵤₘ for each compound over all studies, its EPₛᵤₘ (i.e. the sum of all EP values of a compound over all studies) is divided by the sum of Factor A over all studies in which the compound is involved
h) optionally introducing a weighing factor CA, which is multiplied with the RR value of a compound in order to obtain a “Comparator Adjusted Relative Rank”, CA-RR, wherein CA of each compound is the formerly calculated Summarized Evidence Level (ELₛᵤₘ) of the compound in comparison to which the RR value is determined,
wherein step d) is reiterated and in reiterated step d) CA-RR replaces the RR for each compound of one study in comparison to each other compound along each endpoint in the same study and steps e) to g are reiterated in order to determine Summarized Comparator Adjusted EL (CA-ELsum), which is obtained by performing steps e) to g) upon replacing RR by CA-RR,
i) ranking all compounds along the values ELₛᵤₘ or CA-ELₛᵤₘ
j) determining the best compound for the indented pharmaceutical application, which is the compound with the best value ELₛᵤₘ or CA-ELₛᵤₘ.

Abbreviations used to describe the embodiments of the method are shown in PCT/EP2008/006480 and below:
“Study” STₘ with m=1 . . . ∞ (data of m studies are employed in the method of the present invention).
“Compound” (synonym: entity) Cₒ with o=1 . . . ∞ (over all studies o compounds are tested and can be ranked in the method of the present invention).
“Study Arm” Aₙ with n=1 . . . ∞ (all Measurements of one compound or entity within a study; preferably n Compounds are measured in one study in n study arms).
“Endpoint” (synonym: parameter measured in a study over a population of subjects) Eₚ with p=1 . . . ∞ (over all studies p endpoints are tested and compound can be ranked in the method of the present invention along the endpoints measured)
“Absolute Rank” AR_{q} with AR_{q}=1, 2, 3, . . . n and q=1 . . . n (for n compounds along one endpoint in a study).
“Relative Rank” RR with RR=−1, 0, 1.
“Evidence Points” EP
“Evidence Level” EL
“Comparator Adjusted Relative Rank” CA-RR
“Comparator Adjusted Evidence Points” CA-EP
“Comparator Adjusted Evidence Level” CA-EL

The term “compound” in the second aspect of the invention may be used synonymously with the term “study arm”, since it may be the case that only one compound is used per study arm. Entities other than compounds are equally possible to evaluate with the methodology.

The term “endpoints” is used synonymously with the term “parameters”, since in a medical setting an endpoint is a parameter that is being assessed. Depending on the chosen entity any other endpoint may be used (e.g. side effects, pharmacokinetic measures).

The EL and the CA-EL allow the ranking of compounds or entities regarding their safety, efficacy or any other specific outcome. The EL and CA-EL are obtained by comparison of data related to the compound or entity.

Obtaining the EL and CA-EL is illustrated below:

m Compounds are evaluated in o studies. Studies may compare compounds tested separately in study arms based on the outcome measured by endpoints. Upon collecting the data from the studies (step a)), every compound in a study is assigned to a value of a endpoint (endpoint) measured in this study (step b)).

For every endpoint it is defined how results have to be interpreted. Values may be defined to be “better” in case they are higher, lower or closer to a range for continuous variables or a specific better value is defined for categorical variables (for details see Examples).

In step b) for every study all endpoints are assigned or plotted against all compounds in this study. Alternatively one may provide tuples (i.e. a pair of values) of (endpoint/study arm) and combine any endpoint with any compound in a study. In this manner every compound is assigned to any endpoint in a study.

In step c) a ranking is introduced by comparison of the compounds for each endpoint of a study separately. The “Absolute Rank” (AR) AR=1 is assigned to the best compound for a particular endpoint of a study. Following the order of inferiority the second best compound is assigned AR=2, the third best compound AR=3 and so on.

In step c) a ranking is introduced by comparison of the compounds for each endpoint of a study separately. The “Absolute Rank” (AR) AR=1 is assigned to the best compound for a particular endpoint of a study. Following the order of inferiority the second best compound is assigned AR=2, the third best compound AR=3 and so on.

In step d) the “Relative Rank” (RR) is calculated based on the Absolute Rank (AR). In a pair wise comparison the relationship between two compounds is expressed by the RR for each compound along each endpoint. A compound/endpoint combination is assigned the RR=−1 in case of inferiority, RR=0 in case of parity and RR=1 in case of superiority as compared to another compound/endpoint combination.

Step e) is particularly important for studies including more than two compounds in order to assess the quantity of superiority.

The number of all RRs of one compound which are RR=1 (“superior RRs)” is the “Evidence Points” (EP) per each compound determined in step e).

In step f) the “Evidence Level” (EL) is calculated. The EL is a normalized EP score. The EP will be divided by Factor A, i.e. the product of the number of “compounds in a study minus 1” and the number of endpoints in a study. Thus a ratio of the superior number to the total number of comparisons will be obtained. The result is a percentage 0-100%.

In step g) for each compound its “overall EL value (ELₛᵤₘ)” over all studies is determined. To obtain the ELₛᵤₘ for each compound over all studies, its EPₛᵤₘ (i.e. the sum of all EP values of a compound over all studies) is divided by the sum of Factors A over all studies in which the compound is involved.

It is apparent that for determining EPₛᵤₘ not all of the proceedings steps a) to f) are essential. If the skilled person, e.g. is not interested in obtaining EL values of compounds in a study, he will determine the ELₛᵤₘ values for compounds over all studies immediately.

The ELₛᵤₘ values obtained allow for the comparison of the different compounds over all available data, i.e. in the present case the data derived from the three different studies.

Therefore, the approach allows putting compounds into relation which have not been tested in the same study so-far.

Optionally a weight factor may be introduced (step h)) to adequately reflect the magnitude of superiority of a compound over a comparator compound (e.g. superiority of a compound over placebo will not be weighted as much as superiority over an active treatment)

With the ranking of all compounds along the values ELₛᵤₘ or CA-ELₛᵤₘ or VA-Elₛᵤₘ the best compounds for an intended pharmaceutical application to which study data have been used may be determined.

### DETAILED DESCRIPTION OF THE INVENTION

Due to progresses in research and advances in availability of data especially over the internet incorporating and interpreting all available information is increasingly becoming a challenge. This holds true for many products and services including scientific research and in particular pharmaceutical R&D. Researchers and marketers are struggling to assess the position of their scientific entities (e.g. development compounds) in comparison to competitor entities or products. The establishment of a universal measure or scale is necessary to quantitatively assess superiority or inferiority as compared to peers thus allowing an accurate assessment.

The invention covers two main aspects:

1) In the first aspect of the applications a method is provided for evaluating and comparing compounds according to a variety of characteristics (i.e. categories) employing a universal measure, the Evidence Level.

The basic principle to calculate the Evidence Level (EL, CA-EL) is described in international application PCT/EP2008/006480. An additional method for the calculation of the Value Adjusted Evidence Level (VA-EL) is provided with the present patent application. This is followed by a practical example based on current work to demonstrate proof of concept.

2) In the second aspect of the invention a method is provided for obtaining a positioning of compounds in a given market or in other contexts. Feasibility for further development and assessment of the opportunity will be presented based on a methodology described in this patent application.

In a first step compounds are assessed and compared with each other. The compounds may be characterized by quantitative measures and subsequently mapped utilizing different coordinate systems depending on the application (e.g. for geological applications with polar or spherical coordinate systems, for display of risk/benefit ratios with a Cartesian coordinate system, multidimensional coordinate systems may be applied).

As exemplified in the following the assessment of the risk/benefit ratio of a new pharmaceutical compound is presented in a Cartesian coordinate system to adequately reflect the trade-off associated with risk vs. benefit.

In addition to the methodology calculating the Relative Rank (RR) and subsequently the Evidence Level (EL) as presented in the European Patent Application Nr. 07 015 407.5 and international application PCT/EP2008/006480 the calculation of the Value Adjusted Evidence Level (VA-EL) is described here. The following steps may be seen as additional alternative to the described calculation of the EL or Comparator Adjusted Evidence Level (CA-EL).

Each of the different evaluation steps (EL, CA-EL, and VA-EL) may be flexibly combined_with each other, for example: first the VA-EL and then the CA-EL can be performed or first the EL and then the CA-EL.

### Evidence Level (EL):

In this item the “Evidence Level” (EL) is determined for each compound of a study.

To obtain the EL for each compound in a study, its endpoint (i.e. the number of superior endpoints of a compound) is divided by Factor A, which is the product of the number of endpoints and the number of compounds minus 1 (for more details, see PCT/EP2008/006480), Example 1).

### Comparator Adjusted Evidence Level (CA-EL):

So far only the simple fact of superiority was considered for the EL and as a first improvement the EL of the comparator was considered (CA-EL).

The CA-EL allows weighting the results obtained by pair-wise comparison according to the EL of the compactor. To obtain this weighting factor the Evidence Level (EL) for the comparators is accessed across all studies they were tested in (for more details, see Example 2 of PCT/EP2008/006480).

### Value Adjusted Evidence Level (VA-EL):

Likewise to the CA-EL the VA-EL does include one additional factor as described in the following.

The reason to obtain the VA-EL is that the magnitude of superiority of a compound in a pair-wise comparison may be supportive to achieve an adequate positioning of compounds to each other.

The VA-EL allows weighting the results obtained from pair-wise comparison according to extend of the superiority of a compound in comparison to the comparator.

### Calculation of the VA-EL:

According to step e) of the former patent application the superior compound will be ranked with a Relative Rank (RR)=1. This leads to 1 Evidence Point (EP) for one particular comparison.

The optimal outcome of the endpoint will be defined. This may be any reference point or range depending on the nature of the endpoint (e.g. mean, median, maximum or minimum of a range). This is called the ‘reference value’ (RV).

Study arms 1 and 2 (or respective compounds used in these study arms) are compared with each other.

The values obtained for one endpoint are given for the study arms, SA1 and SA2.

For each endpoint the difference compound specific value (SA2) and the RV will be calculated). This is called ‘Relative Value Difference’ (RVD).

The Relative Value Difference (RVD) is calculated as a measure to assess the magnitude of difference between the two study arms (SA1 and SA2) in relation to the reference value (RV).

This is necessary to adequately reflect the magnitude of change in context of large or small differences.

This makes the RV necessary. A superior SA1 will be closer to the RV and lead to a positive RVD, whereas an inferior SA 1 will result in a negative RVD (please refer to example 1). In the following Compound C1 is used in SA1 and Compound C2 in SA2. In order to reduce complexity in the following it will be only referred to C1 and C2 respectively which implies use of SA1 and SA2 synonymously.

In between step e) and step f) of international application PCT/EP2008/006480 (“second aspect of the invention”) the following steps are introduced. The former steps a) to e) remain unchanged. Followed by

e1) Compound C1 is being assessed (i.e. the result of endpoint Eₚ for C1)

$$\frac{( ( \vert C {2}_{{E}_{p}} - {RV}_{{E}_{p}} \vert ) - ( \vert C {1}_{{E}_{p}} - {RV}_{{E}_{p}} \vert ) )}{max ( ( C {1}_{{E}_{p}} - {RV}_{{E}_{p}} ) ; ( C {2}_{{E}_{p}} - {RV}_{{E}_{p}} ) )} = RV {\overline{D}}_{( C 1 )}$$

e2) The EP for C1 as obtained by “Patent 1, second aspect of the invention, step e)” is multiplied by the RVD_{(C1)} resulting in the VAEP_{(C1)}

RVD_{(C1)}*EP_{(C1)}=VAEP_{(C1)}

e3) To determine the VAEL for C1 the following step is performed in analogy to “Patent 1, second aspect of the invention, step f)”.

All VAEP of C1 within a study are summed up and then divided by Factor A which is the product of the number of endpoints (p) and the number of compounds (o) included in the study minus 1.

$$p * ( o - 1 ) = Factor {A}_{( C 1 )}$$

$$\frac{Σ {VAEP}_{( C 1 )}}{Factor {A}_{( C 1 )}} = {VAEL}_{( C 1 )}$$

In the following steps starting with step f) of PCT/EP2008/006480 (“second aspect of the invention”) the EL will be replace by the VAEL thus leading to the calculation of the VAELₛᵤₘ in step g).

### ABBREVIATIONS

EL=Evidence level
VA-EL=Value adjusted evidence level
VA-EP=Value adjusted evidence point

### RVD=Relative Value Difference

“Study” STm with m=1 . . . ∞ (data of m studies are employed in the method of the present invention).
“Compound” (synonym: entity) Co with o=1 . . . ∞ (over all studies o compounds are tested and can be ranked in the method of the present invention).
“Study Arm” SAn with n=1 . . . ∞ (all Measurements of one compound or entity within a study; preferably n Compounds are measured in one study in n study arms).
“Endpoint” (synonym: parameter measured in a study over a population of subjects) Ep with p=1 . . . ∞ (over all studies p endpoints are tested and compound can be ranked in the method of the present invention along the endpoints measured)

Calculation to assess whether a new compound is positioned within the promising rectangle—General formula

The Euclidean distance between two points P and M is defined as

dist(P,M)=\sqrt{(xₚ−x_{M})²+(yₚ−y_{M})²}. (1)

The coordinates of the centre of the circle (x_{M}, y_{M}) (“sweet spot”) is defined by the medians of the evidence levels Ψ of all products as

$$( {x}_{M} , {y}_{M} ) ⇒ \begin{matrix}{x}_{M} = Median ( {Ψ}_{all products}^{Safety} ) \\ {y}_{M} = Median ( {Ψ}_{all products}^{Efficacy} )\end{matrix} \qquad ( 2 )$$

The coordinates of the launched product E are (x_{M}, y_{M}) with information level Γ_{ε} greater than a predefined limit Γ_{A} and maximum efficacy evidence level Ψ_{E}^{efficacy} of all launched products are

(x_{E},y_{E})=(x,y)·I_{E} (3)

with

$${I}_{E} = \{ \begin{matrix}1 for {Γ}_{E} > {Γ}_{Λ} ⋀ {Ψ}_{E}^{Efficacy} = max ( {Ψ}_{launched products}^{Efficacy} ) \\ 0 else\end{matrix} \qquad ( 4 )$$

The coordinates of the launched product T are (x_{T}, y_{T}) with information level Γ_{T} greater than a predefined limit Γ_{A} and maximum Safety Evidence Level_Ψ_{T}^{Safety} launched products are

(x_{T},y_{T})=(x,y)·I_{T}(5)

with

$${I}_{T} = \{ \begin{matrix}1 for {Γ}_{T} > {Γ}_{Λ} ⋀ {Ψ}_{T}^{Safety} = max ( {Ψ}_{launched products}^{Safety} ) \\ 0 else\end{matrix} \qquad ( 6 )$$

The radius of each circle is defined as

r_{E}=dist(E,M) (7)

r_{T}=dist(T,M) (8)

r_{new}=dist(New,M) (9)

Let φ be in the range of 0≦φ<2π, then φ is defined as

$$ϕ = \{ \begin{matrix}arccos \frac{( {x}_{new} - {x}_{M} )}{{r}_{new}} for ( {y}_{new} - {y}_{M} ) \geq 0 \\ 2 π - arccos \frac{( {x}_{new} - {x}_{M} )}{{r}_{new}} for ( {y}_{new} - {y}_{M} ) < 0\end{matrix} \qquad ( 10 )$$

and

(x_{new}−x_{M})=r_{new}·cos φ (11)

and

(y_{new}−y_{M})=r_{new}·sin φ (12)

Then the limits of the part of interest of the circle is defined for the upper limit as

$${ϕ}_{upper} = \{ \begin{matrix}arccos \frac{( {x}_{E} - {x}_{M} )}{{r}_{E}} for ( {y}_{E} - {y}_{M} ) \geq 0 \\ 2 π - arccos \frac{( {x}_{E} - {x}_{M} )}{{r}_{E}} for ( {y}_{E} - {y}_{M} ) < 0\end{matrix} \qquad ( 13 )$$

and for the lower limit as

$${ϕ}_{lower} = \{ \begin{matrix}arccos \frac{( {x}_{T} - {x}_{M} )}{{r}_{T}} for ( {y}_{T} - {y}_{M} ) \geq 0 \\ 2 π - arccos \frac{( {x}_{T} - {x}_{M} )}{{r}_{T}} for ( {y}_{T} - {y}_{M} ) < 0\end{matrix} \qquad ( 14 )$$

Let Iₓ, I_{y}, Iᵣ, Iᵣ₂, I_{φ}^{limit} be indicator functions as defined below

$$\begin{matrix}{I}_{x} = \{ \begin{matrix}1 if {x}_{new} \geq {x}_{E} \\ 0 else\end{matrix} & ( 15 ) \\ {I}_{y} = \{ \begin{matrix}1 if {y}_{new} \geq {y}_{T} \\ 0 else\end{matrix} & ( 16 ) \\ {I}_{r} = \{ \begin{matrix}1 if max ( {r}_{E} , {r}_{T} ) \geq \sqrt{{( {x}_{new} - {x}_{M} )}^{2} + {( {y}_{new} - {y}_{M} )}^{2}} \\ 0 else\end{matrix} & ( 17 ) \\ {I}_{r 2} = \{ \begin{matrix}1 if max ( {r}_{E} , {r}_{T} ) \geq \sqrt{{( {x}_{new} - {x}_{M} )}^{2} + {( {y}_{new} - {y}_{M} )}^{2}} \\ 0 else\end{matrix} & ( 18 ) \\ {I}_{ϕ}^{limit} = \{ \begin{matrix}\begin{matrix}0 if {ϕ}_{upper} < {ϕ}_{lower} and ϕ > {ϕ}_{upper} and ϕ < {ϕ}_{lower} \\ 0 if {ϕ}_{upper} \geq {ϕ}_{lower} and ( ϕ > {ϕ}_{upper} or ϕ < {ϕ}_{lower} )\end{matrix} \\ 1 else\end{matrix} & ( 19 )\end{matrix}$$

The coordinates (x_{new},y_{new}) are inside the upper right rectangle including the part of interest of the circle (please refer to FIG. 1a)) when X_{complete} is equal 1, wherein

X_{complete}=Iₓ·I_{y}·I_{φ}^{limit} (20)

The coordinates (x_{new},y_{new}) are within the part of interest of the circle (please refer to FIG. 1b)) when X_{within} is equal 1, wherein

X_{within}=Iₓ·I_{y}·Iᵣ·I_{φ}^{limit} (21)

The coordinates (x_{new},y_{new}) are outside the part of interest of the circle but inside the upper right rectangle (please refer to FIG. 1c)) when Xᵤₚₚₑᵣ is equal 1, wherein

Xᵤₚₚₑᵣ=Iₓ·I_{y}·Iᵣ₂·I_{φ}^{limit} (22)

### Definition of “Realistic Corridor”

Method: linear regression to model the efficacy evidence level (dependent variable) by the safety evidence level (independent variable):

Y=μ+β·X+ε

Y: Dependent variable (Efficacy Evidence Level)
X: Independent variable (Safety Evidence Level)
μ: intercept
ε: random error
X: slope of the regression line
The regression model may be based on the entire population (e.g. of compounds) or sub-sets. The regression curve may then be shifted parallel to the original regression curve to a predefined minimum or maximum point in the coordinate system, e.g. defined by an approved compound with minimal or maximal safety or efficacy. Two lines parallel to the original regression line are the result defining an area which is called the “realistic corridor”. This area is further limited by the limits of the “promising quadrate (please also refer to FIG. 2f)).

### LIST OF FIGURES

FIG. 1a) demonstrates the area of the “opportunity rectangle” and the “sweet spot circle sector” which are both hatched.

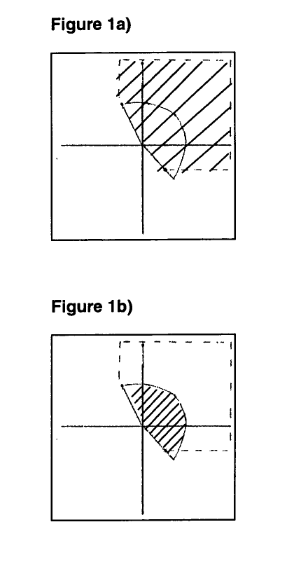

FIG. 1b) demonstrates the hatched area of the “sweet spot circle sector”.

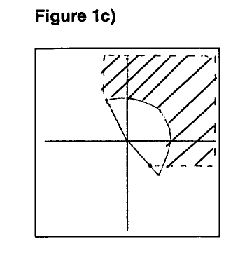

FIG. 1c) shows the area of the opportunity sector minus the area of the “sweet spot circle sector”.

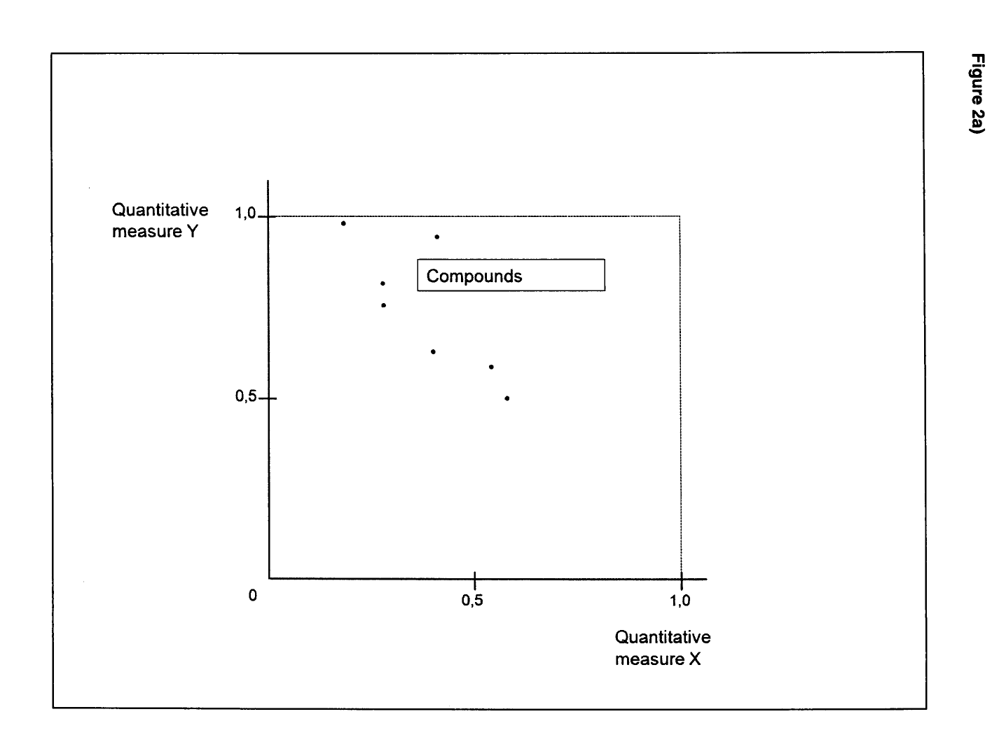

FIG. 2a) displays the Efficacy Evidence Level (EL) of a compound (Y-axis), and the Safety EL (X-axis). Compounds are positioned in the Cartesian coordinate system, accordingly.

FIG. 2b) shows four straight lines forming the “promising rectangle” (each in parallel to the X- and Y-axis): Their position equals the compound with the lowest “X-value”, the lowest “Y-value”, the maximally achievable Y-value, and the maximally achievable X-value.

FIG. 2c) shows the median of the X- or Y-values of all approved compounds. The intersection of the two lines representing the median safety and efficacy is called the “sweet spot”. The sweet spot is the centre of a large “sweet spot circle”. Large sweet spot circle means, that the underlying circle has a relatively large radius due to the position of the underlying compound location in the coordinate system.

FIG. 2d) depicts a part of a large “sweet spot circle”, a so-called “sweet spot circle sector”. The left/upper and the right/lower limit of the “sweet spot circle sector” are defined by the compounds within the underlying “sweet spot circle” with the “best safety” or “best efficacy”.

FIG. 2e) displays an “opportunity sector” which is part of a larger “sweet spot circle sector”. In this example the “opportunity sector is part of the “sweet spot circle sector” and closest towards the point of “ideal” Y/X ratio (highest “X measure” and “Y measure”: 1/1 ratio) and not including other compounds at the same time, therefore indicating a market niche

FIG. 2f) shows a “realistic corridor” which is the area between two curves drawn parallel to the regression curve calculated from the X- and Y-values of the compounds. The compounds which mark the limits of the realistic corridor in addition to the “promising quadrate” are indicated, too. Please note: For this example not all compounds are shown which have been used for the calculation of the regression curve.

FIG. 2g) shows a small “sweet spot circle sector” (i.e. the underlying “sweet spot circle” has a relatively small radius) as an example for “sweet spot circles” with smaller diameter.

FIG. 3a) shows the Safety and Efficacy Evidence Levels for 10 compounds which have already been launched for Indication I. Each dot represents one compound with a particular dosage and mode of application (e.g. intravenous application, oral application).

FIG. 3b) demonstrates the safety/efficacy ratio of the 3 dosages of compound A in comparison to ten competitors.

FIG. 3c) demonstrates the “promising rectangle” for this evaluation. Compound 2 and 8 which represent the highest possible Safety and Efficacy Evidence Levels of already launched compounds define the limits of the “promising rectangle”.

FIG. 3d) shows the “sweet spot” and a sector of one corresponding “sweet spot circle”. The “sweet spot” represents the “optimal” benefit/safety ratio in the market for the treatment of Indication I and is defined by the crossing of the straight lines of the “Median Safety Evidence Level” and the “Median Efficacy Evidence Level”. The sweet spot serves as the centre of “sweet spot circles”.

FIG. 3e) demonstrates the “opportunity sector” which is limited by (i) “Sweet spot circle sector”, (ii) Compound 5 (no other compound has better safety) and (iii) Compound 6 (no other compound has better efficacy). This is the so-called “opportunity sector” where no other Competitor is located.

FIG. 3f) demonstrates the main locations with the coordinate system as exemplified by the three different dosages of Compound A:
1. Outside the “promising rectangle”
   (Compound A, 10 mg)
2. Inside the “promising rectangle” and inside the predefined “opportunity sector” (Compound A, 50 mg)
3. Inside the “promising rectangle” but outside of the predefined “opportunity sector” (Compound A, 100 mg)

FIG. 4a) shows all launched products (black) and not-launched compounds (grey) for an autoimmune disease. The Y-axis displays the efficacy Evidence Level (EL) of a compound, the X-axis the respective safety EL. The size of the circles depends on the number of endpoints that have been tested for a compound (the bigger the size of the circle the more endpoints have been evaluated to calculate the Evidence Level).

FIG. 4b) shows the “promising rectangle”. The lower and the left limit are marked by the compounds with the lowest Efficacy and Safety Evidence Level, respectively.

FIG. 4c) shows a large “sweet spot circle sector”. The radius is defined by the launched compound Alpha 40. The limits of the “sweet spot circle sector” are built by the launched compounds with most efficacy and most safety covered by the respective sweet spot circle.

FIG. 4d) demonstrates the “opportunity sector”: The “opportunity sector” defines an area being closest towards the point of an “ideal” benefit/risk ratio (highest possible efficacy evidence level and highest possible safety evidence level: 1/1 ratio) which does not cover other compounds at the same time (not-launched compounds are not considered in this analysis).

FIG. 4e) shows a “realistic corridor” which is the area between two curves drawn parallel to the regression curve calculated from the Safety and Efficacy Evidence Values of the compounds already launched in the autoimmune disease under evaluation. Sigma 0.6 mg marks the left limit and Phi 0.2 marks the right limit of the X- and Y-values of the compounds. In addition, the “realistic corridor” is marked by the limits of the “promising quadrate”.

### DEFINITIONS

A “target” is a structure (such as a protein or nucleic acid) within an organism (including viruses, animals, plants, fungi, bacteria) whose activity can be modified by an external stimulus.

In this context the term compound is used for (1) any substance used for diagnostic, therapeutic and prophylactic purposes consisting out of natural or synthetically produced and where applicable (pharmaceutically) specifically manufactured active ingredients.

The term is also used for the combination of two or more compounds or the composition of ingredients. Additionally, various characteristics of the compounds, combination of compounds or ingredients of the compounds may be investigated. Such characteristics may include physical (melting point, ultraviolet absorption, . . . ), chemical (molecular weight, solubility, . . . ) or biological features (Target, Pathway, Mode of Action, PK/PD).

Additionally, the term compound is used for (2) suture material, disinfectants, diagnostics and several assistive medical devices, e.g. pacemaker and contact lenses.

In this context “efficacy” is the therapeutic effect of a drug on a disease or an affected subject and “safety” refers to the side effects of the drug on the organism.

The term “compound” covers all substances or measure (e.g. surgical approaches) which may impact on a biological function in vivo and in vitro. A compound may be a therapeutic protein (comprising artificial and/or natural amino acids), a therapeutic nuclear acid (preferably DNA, RNA, Peptide Nucleic Acid (PNAI) etc), or a so-called small molecules (preferably an organic molecule or anorganic molecule). Also mixtures of compounds are contemplated. Compounds are sometimes also referred to as “active agents”.

Compounds may be characterized by their mode of administration. Two compounds may be distinct compounds in the sense of the present application, if they are to be administered in a different mode. The mode of administration may be characterized by the dose, amount or concentration of the compound or by the route of administration, e.g. oral, nasal, buccal, parenteral, intravenous, enteral, or by different concentrations of compound or therapeutic schedule of the compound, etc.

The described invention may be used for other applications not evaluating compounds but other entities. The term compound will be used synonymously.

An “entity” is something that has a, separate existence, preferably a material existence. Examples of entities contemplated in the present invention cover a broad range of various products/services from different industries.

Besides pharmaceutical compounds also products from agriculture (e.g. fruits, vegetables), forestry (e.g. trees), fishing (fishes, seafood), mining (copper, iron) quarrying (e.g. marble, granite), electrical equipment, electricity, gas (e.g. natural gas), construction (buildings, bridges) or fabricated metal products, motor vehicles, motorcycles, electronic or optical products are contemplated. Services may comprise services in the field of trade; repair of motor vehicles and motorcycles, financial and insurance activities, professional, scientific or technical activities (legal and accounting activities; etc). Entities may replace compounds throughout the methods of the present invention.

A category is defined as a class of entities of a particular hierarchic level.

Within a category a candidate compound or entity can be compared with other compounds or entities. Depending on the nature of data (quantitative data or qualitative data) compounds or entities can be ranked or arranged along a metric scale:

Within a category a particular (candidate) compound can be compared with other compounds, depending on the nature of data:
1. Quantitative measures can be directly used in an “Opportunity Sector Analysis”.
2. Qualitative data can be used to further characterize subgroups of the qualitative measures described under (1).

Examples for qualities are:
Different classifications for various types of targets (e.g. Imming et al., 2006)
Different classifications of drugs (e.g. agonist, antagonist, partial agonist)
Status of clinical trial(s) with compound(s) binding to the same target as the compound under evaluation (e.g. compound launched, registered, pre-registration, successful phase III study, phase III study prematurely terminated, . . . )
Development status of compound(s) (e.g. compound launched, registered, pre-registration, successful phase III study, phase III study prematurely terminated, . . . )

Examples for quantities are:
Area under the curve (AUC)
Bioavailability
Half life of the compound (t½)
Interval between two time-points of drug administration
Number of clinical trials of the compound under evaluation in pathophysiologically related indications
Number of clinical trials of the compound under evaluation in pathophysiologically un-related indications

In another preferred embodiment “compound benchmarks” are particular qualities, which are assignable to a compound.

As illustrated above, there are several approaches, which may increase the quality of compound assessment and may help to better predict the outcome of drugs in development.

This process is further supported by the fact that the data can be visualized in various ways. This allows identifying and assessing relevant data and critical issues allowing for an informed decision-making with greater ease of use.

The novel combination of the features according to the method of PCT/EP2008/006480 and the present invention make the “Opportunity Sector Analysis Tool” a major help for evaluating compounds.

Additionally, methods of network theory can be applied to the current invention.

[Definition: “A network is a set of items, which we will call vertices or sometimes nodes, with connections between them, called edges”; (Newman, 2003)]. Examples for nodes within a network are any putative combination of two or more of the following terms (for the compound under evaluation and the comparator compounds and for the target indication and related indications): Compound, Target, Pathway, mode of action (in case of compounds), patho-mechanism (in case of diseases), efficacy, safety, study design (incl. timelines, study population, baseline characteristics, endpoints, biomarkers, costs)

Terms and algorithms like “centrality, closeness centrality, betweenness centrality, eigenvector centrality” and others have been applied to analyses in “Network biology” (Newman, 2003; Barabasi and Oltvai, 2004). The results of these network analyses will even be evaluated with the help of Frequentist and Baysian mathematical approaches. Correlation and Cluster analyses may be performed.]

The Evidence Level (EL), the Value Adjusted Evidence Level (VA-EL) and the Comparator Adjusted Evidence Level (CA-EL) allow the ranking of compounds or entities regarding their safety, efficacy or any other specific outcome. The EL and CA-EL are obtained by comparison of data related to the compound or entity.

In the context of this patent application mean is defined as the arithmetic mean (and is distinguished from the geometric mean or harmonic mean) and as the “expected value of a random variable, which is also called the population mean”. It may be applied in form of the different subtypes of mean (e.g. arithmetic mean, harmonic mean, generalized means, weighted arithmetic mean) (http://en.wikipedia.org/w/index.php?title=Arithmetic_mean&oldid=249957740; permanent link, accessed as of 20 Nov. 2008).

### Overview of the Invention

The present invention provides a variety of aspects, which are summarized below.

In principal, the methods or uses of the present invention enable to address various questions in different industry sectors related to the question of predicting success and failure of a compound.

The data utilized to address a question are collected, categorized, ranked and evaluated. This includes the compound to be evaluated and those it shall be compared.

Possible entities are various products/services from different industries including (according to Anonymous, 2007a)

A—Agriculture, forestry and fishing

B—Mining and quarrying

C—Manufacturing including manufacture of chemicals and chemical products and Manufacture of basic pharmaceutical products and pharmaceutical preparations.

The term “pharmaceutical” refers in a first aspect to pharmacy or to drugs and in a second aspect to a medicinal drug.

Further types of Manufacture comprise: Manufacture of rubber and plastic products; manufacture of other non-metallic mineral products; manufacture of basic metals, manufacture of fabricated metal products, except machinery and equipment; manufacture of computer, electronic and optical products; manufacture of electrical equipment; manufacture of machinery and equipment; manufacture of motor vehicles, trailers and semi-trailers; manufacture of other transport equipment; manufacture of furniture, repair and installation of machinery and equipment, and other manufacturing)

D—Electricity, gas, steam and air conditioning supply

E—Water supply; sewerage, waste management and remediation activities (water collection, treatment and supply; sewerage; waste collection, treatment and disposal activities; materials recovery; remediation activities and other waste management services)

F—Construction (construction of buildings; civil engineering; specialized construction activities)

G—Wholesale and retail trade; repair of motor vehicles and motorcycles (wholesale and retail trade and repair of motor vehicles and motorcycles; wholesale trade, except of motor vehicles and motorcycles; retail trade, except of motor vehicles and motorcycles)

H—Transportation and storage (land transport and transport via pipelines; water transport; air transport; warehousing and support activities for transportation; postal and courier activities)

I—Accommodation and food service activities (accommodation; food and beverage service activities)

J—Information and communication (publishing activities; motion picture, video and television programme production, sound recording and music publishing activities; programming and broadcasting activities; telecommunications; computer programming, consultancy and related activities; information service activities)

K—Financial and insurance activities (financial service activities, except insurance and pension funding; insurance, reinsurance and pension funding, except compulsory social security; activities auxiliary to financial service and insurance activities)

L—Real estate activities

M—Professional, scientific and technical activities (legal and accounting activities; activities of head offices; management consultancy activities; architectural and engineering activities; technical testing and analysis; scientific research and development; advertising and market research; other professional, scientific and technical activities, veterinary activities)

N—Administrative and support service activities (rental and leasing activities, employment activities; travel agency, tour operator, reservation service and related activities; security and investigation activities; services to buildings and landscape activities; office administrative, office support and other business support activities)

O—Public administration and defence; compulsory social security

P—Education

Q—Human health and social work activities (human health activities; residential care activities; social work activities without accommodation)

R—Arts, entertainment and recreation (creative, arts and entertainment activities; libraries, archives, museums and other cultural activities; gambling and betting activities; sports activities and amusement and recreation activities)

S—Other service activities (activities of membership organizations; repair of computers and personal and household goods; other personal service activities)

T—Activities of households as employers; undifferentiated goods- and services-producing activities of households for own use

U—Activities of extraterritorial organizations and bodies

V—Search for different terms on webpages; a ranking of the terms in comparison to other terms is possible.

### Evaluation of Results

To ensure the highest possible quality of the results each analysis will be divided into two parts: Firstly, a subset of the data may be used as training set to generate the hypothesis. Secondly, this hypothesis will be confirmed with the complementary data part, the validation set.

To model the different characteristics of a compound in discovery and development and to predict the possible long-term success or failure of compounds Bayesian and Frequentist mathematical approaches may be applied.

Additionally, it is intended to analyse the data collected in the “Opportunity Sector Analysis Tool” with the help of algorithms developed for use in “network theory”

### Further Embodiments of the Invention

A variety of additional embodiments are provided, which are related to the present invention.

In one embodiment, a method is provided for determining whether a compound has an improved benefit/risk ratio (or particular characteristics related to benefit or risk) compared to other members in a class of compounds or entities. In this embodiment “improved risk/benefit ratio” means: better safety/efficacy ratio, less toxic effects with same efficacy, better strategic fit in the commercial environment. The comparison is enabled through the position in the coordinate system:
Location within the Promising Rectangle: better safety and/or efficacy than the worst competitor compound.
Location within the limits of a particular “sweet spot circle”: In case of a small “sweet spot circle” the benefit/risk ratio is more balanced than in case of location in a large “sweet spot circle”.
Location within the limits of a “sweet spot circle sector”: The angle of the respective sector defines the location within the coordinate system with a market opportunity for future compounds.

In another embodiment, a method is provided for determining the best candidate in a class of compounds or entities. The “Opportunity Sector Analysis” allows comparing this particular compound with other compounds regarding many different characteristics and therefore enables to identify the best compound among others with regards to a particular market opportunity. The comparison is enabled through the position in the coordinate system:
Location within the Promising Rectangle: better safety or efficacy than the worst competitor compound.
Location within the limits of a particular “sweet spot circle”: In case of a small “sweet spot circle” the benefit/risk ratio is more balanced than in case of location in a large “sweet spot circle”.
Location within the limits of a “sweet spot circle sector”: The angle of the of the respective sector defines the location within the coordinate system with a market opportunity for future compounds

In another embodiment, a method is provided for improving chances to select the best candidate in a class of compounds or entities. The “Opportunity Sector Analysis” improves the probability to identify the best candidate in a class of compounds or entities with regards to a particular market need (for example a particular benefit/risk ratio in combination with a certain mode of administration, e.g. intravenous vs. oral administration).

In another embodiment, a method is provided for testing pharmaceutical compounds or compositions. Safety and efficacy represent “umbrella terms” under which different features of safety and efficacy may be summarized. Therefore, the method may be used to identify the combination of certain strengths and weaknesses of a compound or combinations with regards to a particular market need.

In another embodiment, a method is provided of selecting a pharmaceutical treatment. The method may help to identify the most suitable procedure to treat or cure a patient with the best risk/benefit relationship.

In another embodiment, a method is provided of selecting a pharmaceutical treatment for a patient suffering from a disease, disorder or condition. The method may be used to identify the best treatment or cure for a particular individual. The individual patient may be identified using different methods (e.g. genetic markers and other markers indicative for beneficial or harmful features of a compound) for personalized (i.e. individualized) medicine.

In another embodiment, a method is provided of performing a clinical trial. The method may be used to simulate, prepare or support clinical trials and therefore to test a compound. In more detail, the method is suited to identify the benefit/risk ratio of pharmaceutical compounds which impacts on the clinical trial design (e.g. regarding number of patients in a particular phase of a clinical trial, duration of treatment) based on the data collected for compounds with comparable, superior, inferior characteristics.

In another embodiment, a method is provided of a more or less balanced risk/benefit ratio of a clinical trial or a therapy to succeed. This is achieved by looking at “sweet spot circles” with larger or smaller radius which may help e.g. to determine the consequences of reducing the efficacy with respect to the safety of a compound (for example by dose adaptation). Therefore, this method is suited to optimize the benefit/risk ratio of a compound.

The method may help to optimise the safety features of a compound for treating patients or animals or in in vitro tests. Safety and efficacy represent “umbrella terms” under which different features of safety and efficacy may be summarized. Therefore, the method may be used to identify the combination of certain strengths and weaknesses of a compound or combinations

In another embodiment, a method is provided of reducing risks of a clinical trial. The method may help to identify those hazards of a particular compound which are linked to the specific beneficial features of a compound (immunosuppression achieved by pharmaceutical compounds is wanted after transplantation; at the same time immunosuppression may lead to unwanted infections). The method therefore may help to reduce the risk of side effects of a compound in patients or animals or in in vitro tests.

In another embodiment, a method is provided of increasing safety of a clinical trial or a therapy. The method may help to identify special safety issues of a particular compound which may be linked to beneficial features of a compound and therefore may help to reduce the risk of a compound in patients or animals or in in vitro tests.

In another embodiment, a method is provided of identifying the grade of benefit/risk ratio of a compound. The method helps to characterize both novel and known aspects of target(s) (and their related pathways) and mode of action of a particular compound.

In another embodiment, a method is provided of treatment of a patient or a disease. The method helps to identify the optimal treatment for a particular patient or a disease.

In another embodiment, a method is provided of producing a pharmaceutical composition. The method may be used to identify the best compound for a pharmaceutical composition and therefore form as an essential part of the process when producing a pharmaceutical composition. The pharmaceutical composition may also comprise a combination of two or several compounds obtained with the “Opportunity Sector Analysis” of the present invention.

In another embodiment, a method is provided of identifying new treatment concepts and treatment algorithms (the squeal of different treatments) for a particular disease. The method may be used to identify new or other relevant disease mechanisms to be targeted by new or existing compounds or entities, leading to new treatment concepts of patients or diseases of animals.

All of these methods above may comprise one or more of the steps a) to g) of the method of the first aspect of the present invention (“Opportunity Sector Analysis”).

In addition the following embodiments directed to systems suitable to perform the above methods are provided:
a) A system for determining the best candidate in a class of compounds or entities.
   The invention displays comprehensive information in a way that it can be more easily processed and is therefore assessable for decision making.
b) A system for comparing candidates in a class of compounds or entities. The invention displays comprehensive information in a way that it can be more easily processed and is therefore assessable for decision making.
c) A system for testing pharmaceutical compounds or compositions.
   The invention may be used as procedure to simulate the behaviour of a compound or an entity.
d) Use of system for determining the best candidate for achieving an intended goal in a class of compounds or entities.

In one embodiment a method is provided for comparing different compounds, which may be suitable for the treatment of diseases, for comparing different targets, for comparing different mode of action, different biomedical information, such as pharmacokinetic parameters, molecular properties, etc.

In a further embodiment not compounds but different patients groups may be compared with each other to identify optimal patients for an intended study purpose.

In another embodiment a method is provided for identifying optimal characteristics of study animals.

In another embodiment a method is provided for comparing endpoints or biomarkers regarding their sensitivity and specificity (instead of compounds) with each other.

In another embodiment a method is provided for forecasting future trends in the pharmaceutical market depending on different features of the disease, study type or compound under evaluation.

In another embodiment a method is provided for identifying a particular class of compounds covering certain biological features of compounds (e.g. targets, pathways, or mode of action) with regards to success or failure in particular market sectors.

In another embodiment a method is provided for identifying a particular class of studies with regards to success or failure in particular market sectors.

In another embodiment a method is provided for identifying a particular class of compound covering certain technical features (e.g. molecular weight, solubility) with regards to success or failure in particular market sectors.

### EXAMPLES

### Example 1

### Calculation of the Value Adjusted Evidence Level

### Goal:

Compound I has to be assessed for the treatment of multiple sclerosis.

### Available Experimental Data:

The data of 12 endpoints in one study (here a clinical trial) are available.

In this trial two different compounds have been tested:
a. Compound I (Study arm I)
b. Compound II (Study arm II)

In each study arm only one compound was used. Thus the result of each study arm can be directly attributed to the respective compound. Therefore in this example it will be only referred to Compound I and Compound II.

In patients twelve endpoints (i.e. endpoints of clinical trials) were measured (endpoint i-xii).

The results of the endpoints of the studies (mean value of an endpoint across all patients) are shown below.

The following analysis is simplified. More details (e.g. analysis of numerous studies and various study arms) are provided by international application PCT/EP2008/006480.

### Providing Study Results in a Table:

The results of clinical trials are considered to be the raw data for the further analyses.

Study results may represent different values (e.g.), of a measured endpoint (e.g. . . . ) of the patient population which participated in the particular study arm. In this example endpoints are used (i.e. mean values of respective endpoints measured in a collective of patients in the study).

| | Compound I | Compound II | Reference Value (RV) |
|---|---|---|---|
| Endpoint i | 100 | 50 | 0 |
| Endpoint ii | 400 | 50 | 50 |
| Endpoint iii | 10000 | 8000 | 0 |
| Endpoint iv | 10000 | 8000 | 5000 |
| Endpoint v | 32467 | 300 | 200 |
| Endpoint vi | 700 | 100 | 0 |
| Endpoint vii | 97 | 100 | 50 |
| Endpoint viii | 8500 | 10000 | 0 |
| Endpoint ix | 9000 | 10000 | 5000 |
| Endpoint x | 29700 | 32467 | 125 |
| Endpoint xi | 15 | 20 | 100 |
| Endpoint xii | 20 | 10 | 100 |

### Calculating the Compound Specific Value Difference (CVD)

According to step e) of PCT/EP006480 the superior compound will be ranked with a Relative Rank (RR)=1. This leads to 1 Evidence Point (EP) for one particular comparison.

Compounds I and II are compared with each other.

A reference value (RV) is introduced which describes the best possible result for each endpoint (typically the value of a healthy person).

For each endpoint the difference between the compound specific value and the reference value is calculated. This is called ‘Compound specific Value Difference’ (CVD).

| | | | | Compound | Compound |
|---|---|---|---|---|---|
| | | | | specific | specific |
| | | | Reference | Value | Value |
| | | Comp. | Value | Difference | Difference |
| | Comp. I | II | (RV) | Comp. I | Comp. II |
| Endpoint i | 100 | 50 | 0 | 100 | 50 |
| Endpoint ii | 400 | 50 | 50 | 350 | 0 |
| Endpoint iii | 10000 | 8000 | 0 | 10000 | 8000 |
| Endpoint iv | 10000 | 8000 | 5000 | 5000 | 3000 |
| Endpoint v | 32467 | 300 | 200 | 32267 | 100 |
| Endpoint vi | 700 | 100 | 0 | 700 | 100 |
| Endpoint vii | 97 | 100 | 50 | 47 | 50 |
| Endpoint viii | 8500 | 10000 | 0 | 8500 | 10000 |
| Endpoint ix | 9000 | 10000 | 5000 | 4000 | 5000 |
| Endpoint x | 29700 | 32467 | 125 | 29575 | 32342 |
| Endpoint xi | 15 | 20 | 100 | −85 | −80 |
| Endpoint xii | 20 | 10 | 100 | −80 | −90 |

### Calculating the Maximum Value Difference

The obtained CVD has to be divided by the Maximum Value Difference (MVD) which is the highest absolute difference of either Compound I or Compound II to the RV.

| | | | | Maximum |
|---|---|---|---|---|
| | | | Reference | Value |
| | Comp. I | Comp. II | Value (RV) | Difference |
| Endpoint i | 100 | 50 | 0 | 100 |
| Endpoint ii | 400 | 50 | 50 | 350 |
| Endpoint iii | 10000 | 8000 | 0 | 10000 |
| Endpoint iv | 10000 | 8000 | 5000 | 5000 |
| Endpoint v | 32467 | 300 | 200 | 32267 |
| Endpoint vi | 700 | 100 | 0 | 700 |
| Endpoint vii | 97 | 100 | 50 | 50 |
| Endpoint viii | 8500 | 10000 | 0 | 10000 |
| Endpoint ix | 9000 | 10000 | 5000 | 5000 |
| Endpoint x | 29700 | 32467 | 125 | 32342 |
| Endpoint xi | 15 | 20 | 100 | 85 |
| Endpoint xii | 20 | 10 | 100 | 90 |

### Calculating the Relative Value Difference (RVD)

The Relative Value Difference (RVD) is calculated as a measure to assess the difference between the two compounds (Compound I and Compound II) in relation to the reference value (RV).

The RVD for each endpoint of Compound I is calculated in the table below. Only Compound I is considered in the following since only Compound I is assessed in this example.

| | | | | | Relative |
|---|---|---|---|---|---|
| | | | | Maximum | Value |
| | | Comp. | Reference | Value | Difference |
| | Comp. I | II | Value (RV) | Difference | Comp. I |
| Endpoint i | 100 | 50 | 0 | 100 | −0.5 |
| Endpoint ii | 400 | 50 | 50 | 350 | −1 |
| Endpoint iii | 10000 | 8000 | 0 | 10000 | −0.2 |
| Endpoint iv | 10000 | 8000 | 5000 | 5000 | −0.4 |
| Endpoint v | 32467 | 300 | 200 | 32267 | −0.9969009 |
| Endpoint vi | 700 | 100 | 0 | 700 | −0.8571429 |
| Endpoint vii | 97 | 100 | 50 | 50 | 0.06 |
| Endpoint viii | 8500 | 10000 | 0 | 10000 | 0.15 |
| Endpoint ix | 9000 | 10000 | 5000 | 5000 | 0.2 |
| Endpoint x | 29700 | 32467 | 125 | 32342 | 0.0855544 |
| Endpoint xi | 15 | 20 | 100 | 85 | −0.0588235 |
| Endpoint xii | 20 | 10 | 100 | 90 | 0.1111111 |

### Calculating the Value Adjusted Evidence Point (VA-EP)

For each endpoint now the VA-EP is calculated by multiplying the RVD with the Evidence Point.

(Please note: Since only superiority will be acknowledged, a negative VA-EP is not calculated; please also refer to international application PCT/EP2008/006480).

| | | Relative Value | Value Adjusted |
|---|---|---|---|
| | EP | Difference | Evidence Point |
| | Comp. I | Comp. I | Comp. I |
| Endpoint i | 0 | −0.5 | 0 |
| Endpoint ii | 0 | −1 | 0 |
| Endpoint iii | 0 | −0.2 | 0 |
| Endpoint iv | 0 | −0.4 | 0 |
| Endpoint v | 0 | −0.9969009 | 0 |
| Endpoint vi | 0 | −0.8571429 | 0 |
| Endpoint vii | 1 | 0.06 | 0.06 |
| Endpoint viii | 1 | 0.15 | 0.15 |
| Endpoint ix | 1 | 0.2 | 0.2 |
| Endpoint x | 1 | 0.0855544 | 0.0855544 |
| Endpoint xi | 0 | −0.0588235 | 0 |
| Endpoint xii | 0 | 0.1111111 | 0.1111111 |

### Calculating the Value Adjusted Evidence Level is Calculated (VA-EL)

To determine the VA-EL for Compound I the following step is performed (according to international application PCT/EP2008/006480).

All VA-EP of Compound I are summed up and then divided by Factor A which is the product of the number of endpoints and the number of compounds included in the study minus 1.

(Please note: Since the EP is the sum or number of all superior Relative Ranks (RR) only positive VA-EP are considered).

Sum VA-EPs Compound I: 0.606

Factor A: 12 endpoints*(2 compounds−1)=12

Value Adjusted Evidence Level Compound I: 0.606/12=0.0505

Interestingly, the “conventional” Evidence Level would have been 0.41 for Compound I. The Value Adjusted Evidence Level may be especially helpful in case of endpoints for which a compound is only slightly superior in comparison to the comparator as in the above case, because the “all or nothing” principle of the “conventional” Evidence Level in this case might overestimate the extend of superiority.

### Example 2

### General Application of the “Opportunity Sector Analysis”

In the following the practical application of the calculated EL (or CA-EL or VA-EL) will be demonstrated (i.e. second aspect of the invention).

The typical path of a new pharmaceutical compound leads through different stages of research and development. Starting with laboratory research subsequent development stages are Phase I, II, III before a compound may be approved for marketing by regulatory agencies.

In the pharmaceutical industry the evaluation and comparison of approved compounds (marketing approval by regulatory authorities) and compounds in development is a challenge due to the complexity of the underlying data.

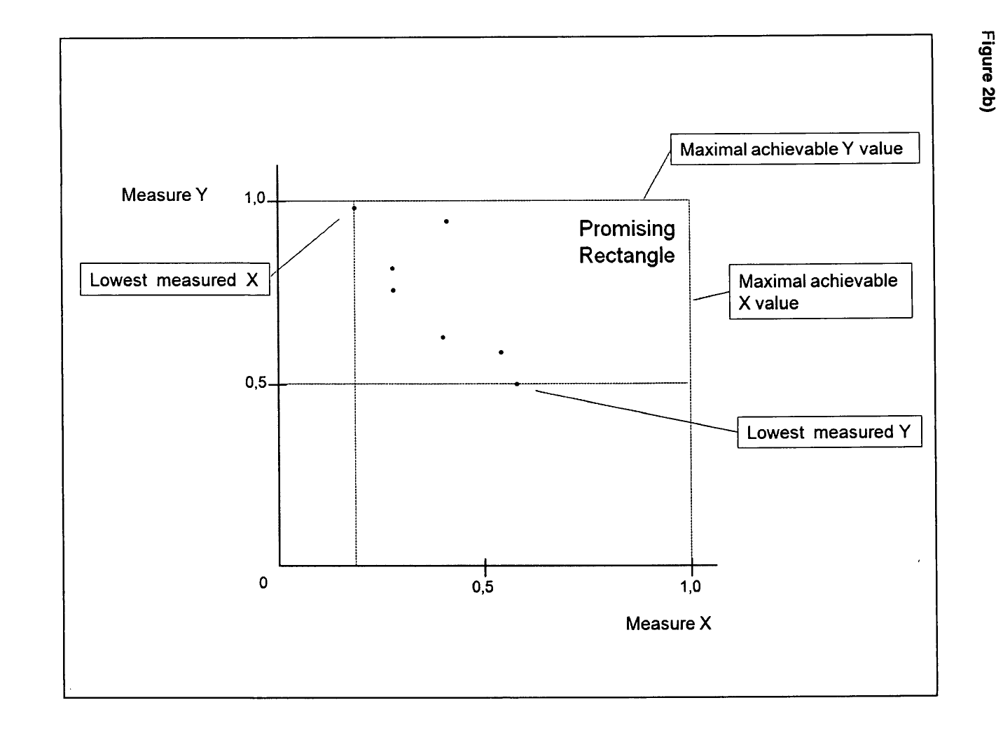

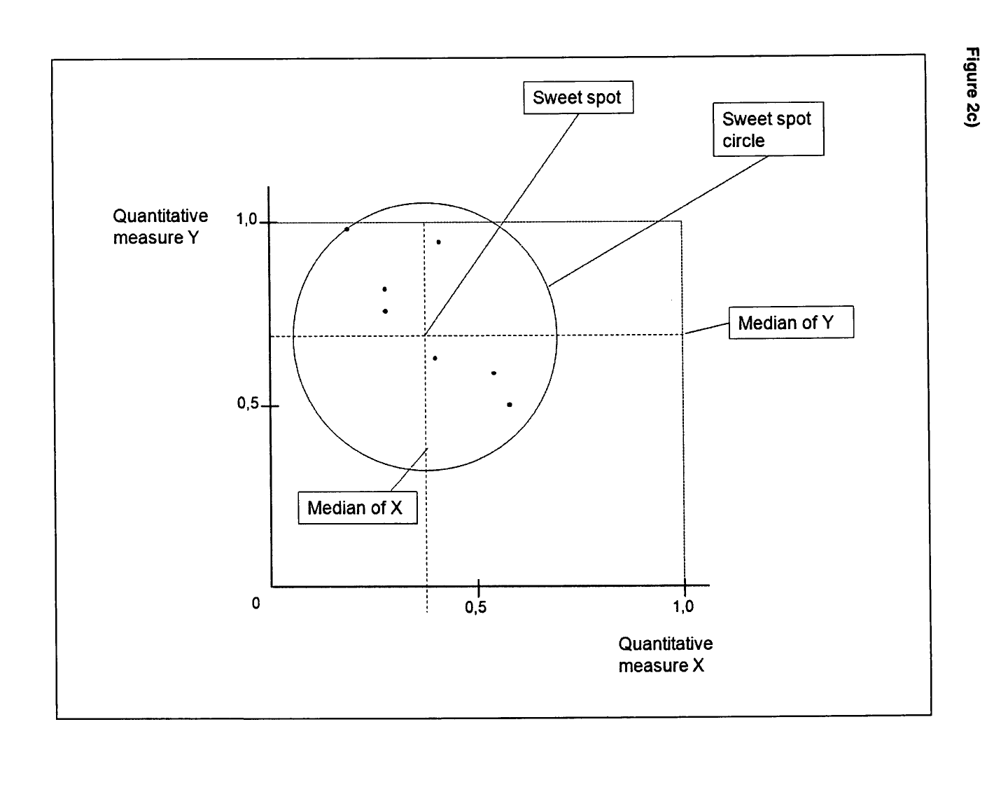

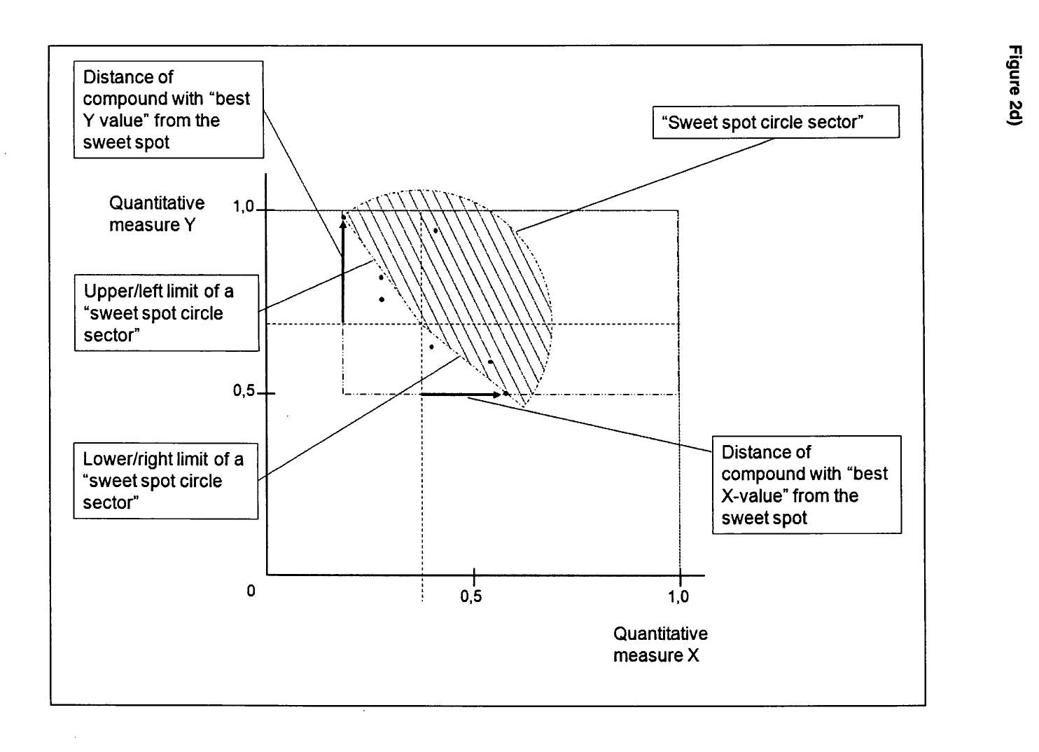

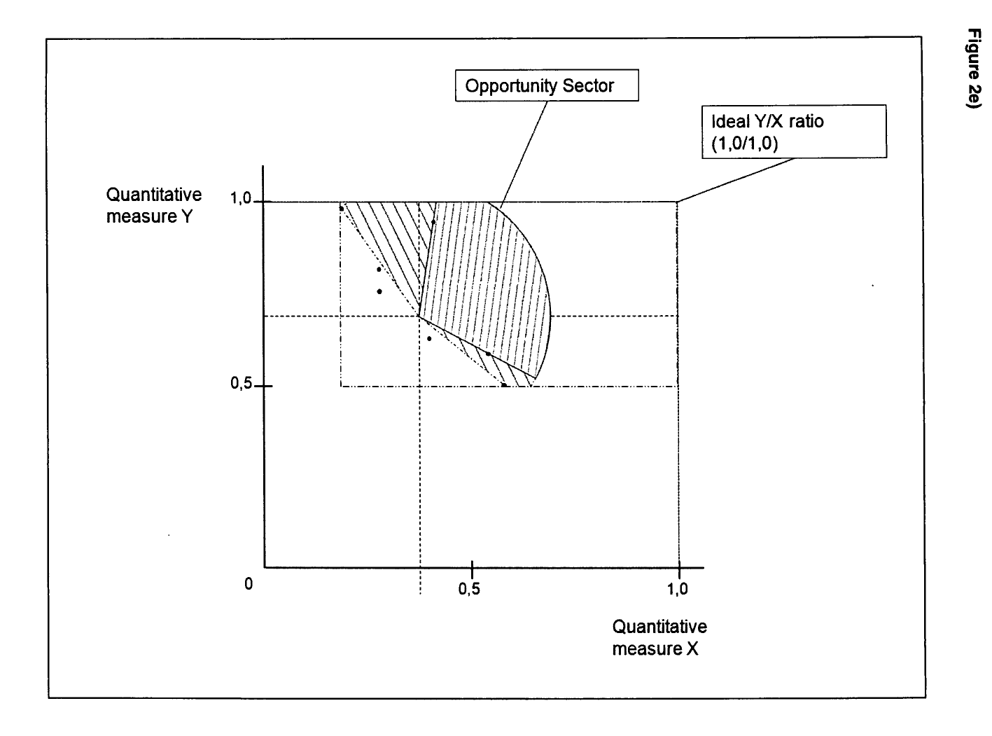

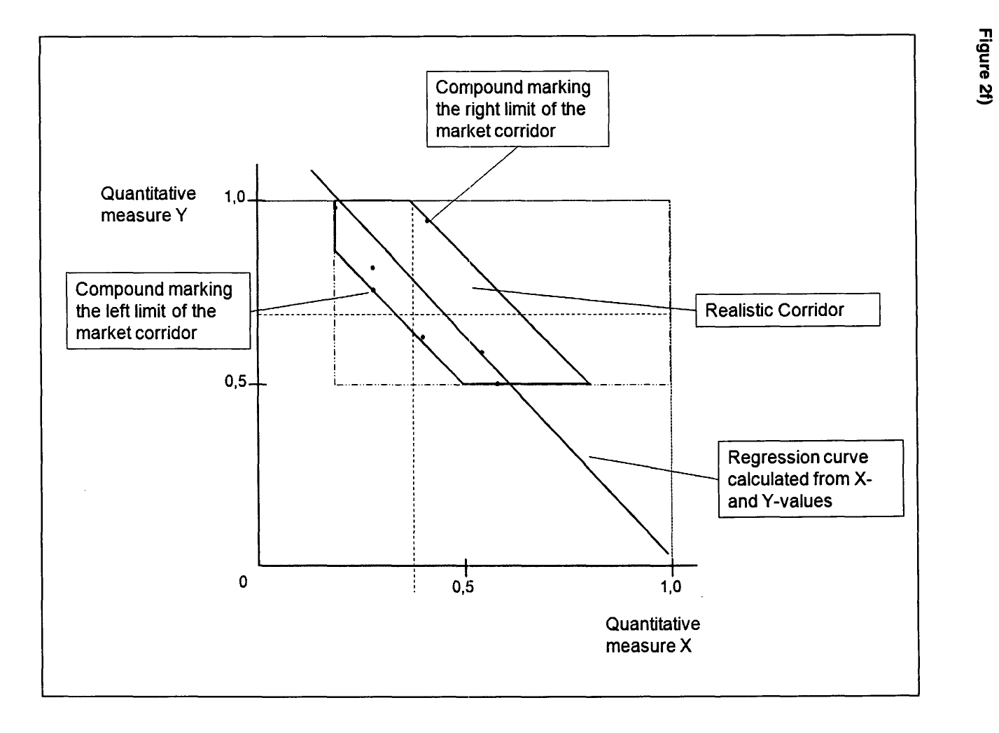

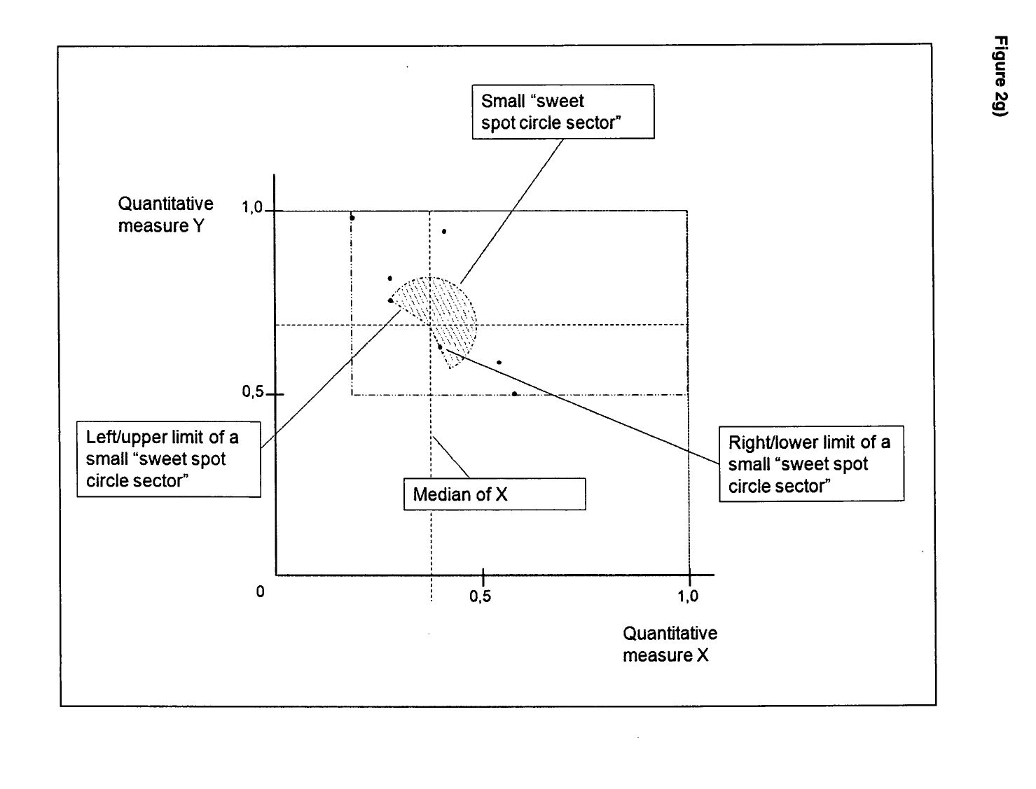

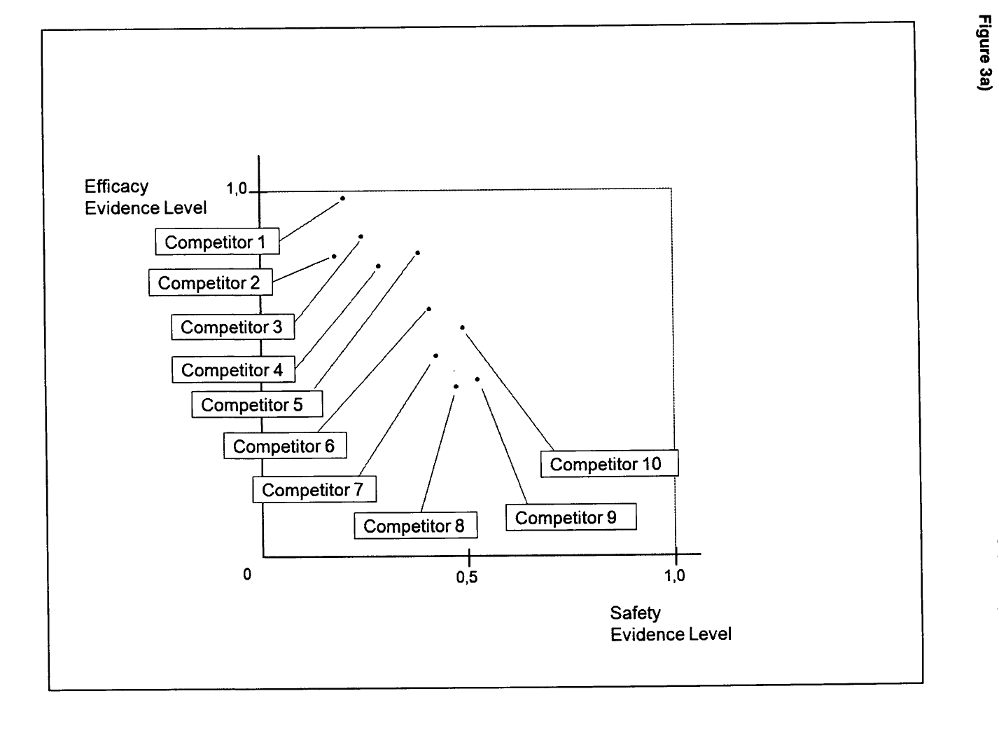

The application of the Evidence Level as set in PCT/EP006480 does improve this task. In FIG. 2a) the Y-axis displays the efficacy EL of a compound, the X-axis the respective safety EL. Compounds are positioned in the Cartesian coordinate system accordingly.

In a next step (FIG. 2b)) straight lines (in parallel to the X- and Y-axis) are drawn. In this example their position equals the compound with the lowest “X-value” and the lowest “Y-value” respectively.

Additionally, straight lines are drawn through the maximally achievable Y-value and through the maximal achievable X-value, each parallel to the X- and Y-axis. The resulting rectangle is called “promising rectangle”.

In general, straight lines parallel to the X- and Y-axis may be drawn through every point in the Cartesian coordinate system, defined e.g. by a compound with a efficacy or safety level in a particular disease or a related diseases or certain scientific or regulatory requirements.

In the following two additional straight lines parallel to the Y- and X-axis are drawn representing the median of the X- or Y-values of the approved compounds (FIG. 2c)). The position of these additional lines may be defined in different ways: Depending on the nature of the data means, medians or other calculations may be used. Also other subsets of compounds may be assessed.

The median is “described as the number separating the higher half of a sample, a population, or a probability distribution, from the lower half” (http://en.wikipedia.org/w/index.php?title=Median&oldid=248520711; permanent link, accessed as of 31 Oct. 2008).

The resulting lines “median of Y” and “median of X” provide a point of reference in order to assess the necessary and relevant efficacy and safety level of a pharmaceutical compound in a given market. A market may be defined according to indications (e.g. multiple sclerosis, rheumatoid arthritis), combinations of those or other areas of application.

Importantly the opposing “sense” (or implied meaning) of the X- and Y-axis (safety vs. efficacy) has to be noted. Pharmaceutical compounds usually have to balance a higher efficacy (favoured action of the drug) with lower safety (un-favoured action or side effects). This applies also to other applications like in investment banking the trade-off between a higher rate of interest (favoured action) versus the higher risk (not favoured action) which is typically associated.

In our graph, both the favourable X- and the Y-values have higher values. Thus an ideal compound would be found in the upper right corner (both Y- and X-values: 1.0: safety/efficacy ratio 1.0/1.0). However, such an ideal may be unlikely to find and thus a more realistic assessment of a market situation is necessary.

The intersection of the two lines representing the median safety and efficacy is called the “sweet spot”. This is a reference point providing the optimal risk/benefit ratio for the assessed compounds of a given market. The sweet spot is the centre for geometric figures, preferably ellipses or circles which are called “sweet spot circles” (FIG. 2c)).

In general, the sweet spot can be every point in the Cartesian coordinate system, defined e.g. by a compound with an efficacy or safety level in a particular disease or a related diseases or certain scientific or regulatory requirements.

In the following and as displayed in FIG. 2d) only “sweet spot circle sectors” are used. Sweet spot circle sectors describe an area that includes a reasonable and realistically achievable risk/benefit ratio of a compound.

In a typical case the upper/left limit of the “sweet spot circle sector” is defined by an approved compound with the highest efficacy and the lower/right limit is defined by an approved compound with the highest safety (FIG. 2d)). The left/upper and the right/lower limit of the “sweet spot circle sector” are defined by the compounds within the underlying “sweet spot circle” with the “best safety” or “best efficacy”.

Depending on the intention of the analysis, the upper/left limit and lower/right limit of the “sweet spot circle sector” may be defined by every point in the Cartesian coordinate system, defined e.g. by any compound or virtual point laying within the “sweet spot circle”.

The point determining the radius of the sweet spot circle may be each point within the Cartesian coordinate system. However, typically the point is defined by a compound with a particular safety/efficacy ratio. The upper and the lower border of the “sweet spot circle sector” are then defined by the compounds within the “sweet spot circle” with the best efficacy or safety, respectively. Preferably, the radius of the “sweet spot circle” is defined by the largest distance from the sweet spot to the point in the coordinate system of either highest x value (safety) or highest y value (efficacy).

The “sweet spot circle sector” is obtained by determining the sector of the “sweet spot circle”, which is limited by two straight lines drawn through the “sweet spot” and the point of the compound with the highest x value (safety) and the point of the compound with the highest y value (efficacy) covered by the respective “sweet spot circle”, and by limiting the obtained sector to the area within the “promising rectangle”.

Since other approved compounds may be within the promising rectangle but outside the sweet spot circle sector it may become necessary to introduce additional sweet spot circle sectors with a smaller radius but larger angle (FIG. 2g)). Accordingly, the left/upper and the right/lower limit of the “sweet spot circle sector” are defined by the compounds within the underlying “sweet spot circle” with the “best safety” or “best efficacy”.

The use of several sweet spot circle sectors may be understood as an approximation toward an area covering an exact image of a reasonable and realistic risk/benefit profile. Thus other ways to describe this area geometrically (e.g. ellipses) are employable as well.

As a result of the evaluation process an objective assessment is possible, since it is based on the calculated Evidence Level.

In a next step an “opportunity sector” is described (FIG. 2e)).

The opportunity sector defines an area being the closest towards the point of the ideal and not including other compounds at the same time. In the current example the “ideal” risk/benefit ratio is located in the upper/right corner (highest possible efficacy and safety evidence level, i.e. maximal efficacy/safety ratio: 1.0/1.0). In other cases the point of ideal may be located in other areas of the Cartesian coordinate system (e.g. lower/left corner).

The radius is chosen as defined by the sweet spot circle sector. The opportunity sector represents an area of high market potential for future compounds and still being within a realistic reach as defined by the radius.

Typically the limits of the “opportunity sector” are defined by compounds which are already marketed. However, in general each of the limits may be defined by other compounds (e.g. expected to reach the market soon) or any virtual point within the Cartesian system (e.g. derived from market research).

However, compounds outside of the radius of the sweet spot circle sector might sometimes also be considered if they are covered by a sweet spot circle with greater diameter and an opportunity sector with the same limits as described above.

Since other geometric shapes may be utilized for the “Opportunity Sector Analysis” the limit of the “opportunity sector” may be the result of the combination of different geometric figures (e.g. an ellipse and two straight lines two or more circles).

There are three principal possibilities where a point in the coordinate system can be located (FIG. 2e)):

(1) Outside the “promising rectangle”

(2) Inside the “promising rectangle” and inside of the “opportunity sector”

(3) Inside the “promising rectangle” but outside of the “opportunity sector”

Similar to the “Opportunity Sector Analysis” for compounds an “Opportunity Sector Analysis for indications” may be performed; indications may be analyzed and may be compared with other indications based e.g. on the respective sweet spot.

Additionally, the identification of alternative indications for a given compound is possible. Moreover, various scenarios for research and development of a pharmaceutical compound may be compared including the comparison of sensitivity and specificity of different study designs.

Moreover, other aspects in quantitative aspects in research, development and in the market may be compared (e.g. costs, prevalence of a disease, timelines, dose, treatment interval).

Alternatively to the “opportunity sector analysis” a “realistic corridor analysis can be performed. FIG. 2f) shows a “realistic corridor” which is the area between two curves drawn parallel to the regression curve calculated from the X- and Y-values of selected compounds (e.g. those which have been approved). The compounds which mark the limits of the realistic corridor in addition to the “promising quadrate” are indicated, too. Please note: For this example not all compounds are shown which have been used for the calculation of the regression curve

The result of the regression analysis displays the interrelation of safety and efficacy for the entire market. Parallel lines which lie on either the minimum or maximum X-value of an approved compound are drawn. These define the realistically achievable corridor.

The approach of the present invention can be used to optimize the development plan. Even the preparation of a pharmacovigilance plan and analysis of safety data can be supported. Furthermore, the obtained data can be used for marketing purposes and for licensing activities, investment decisions (investors, analysts), technological developments (early detection of new methodologies applied, supporting technology suppliers/supply chain companies to plan capacities and own developments in this area).

### Example 3

### Calculation Whether a Compound a is within the Promising Rectangle

Compound A has to be developed in the indication I.

Compound A has already shown promising safety and efficacy data in a phase II dose finding study in indication I at three dosages (10 mg, 50 mg, and 100 mg). With the help of the presented patent application the best dosage for the current market situation has to be identified.

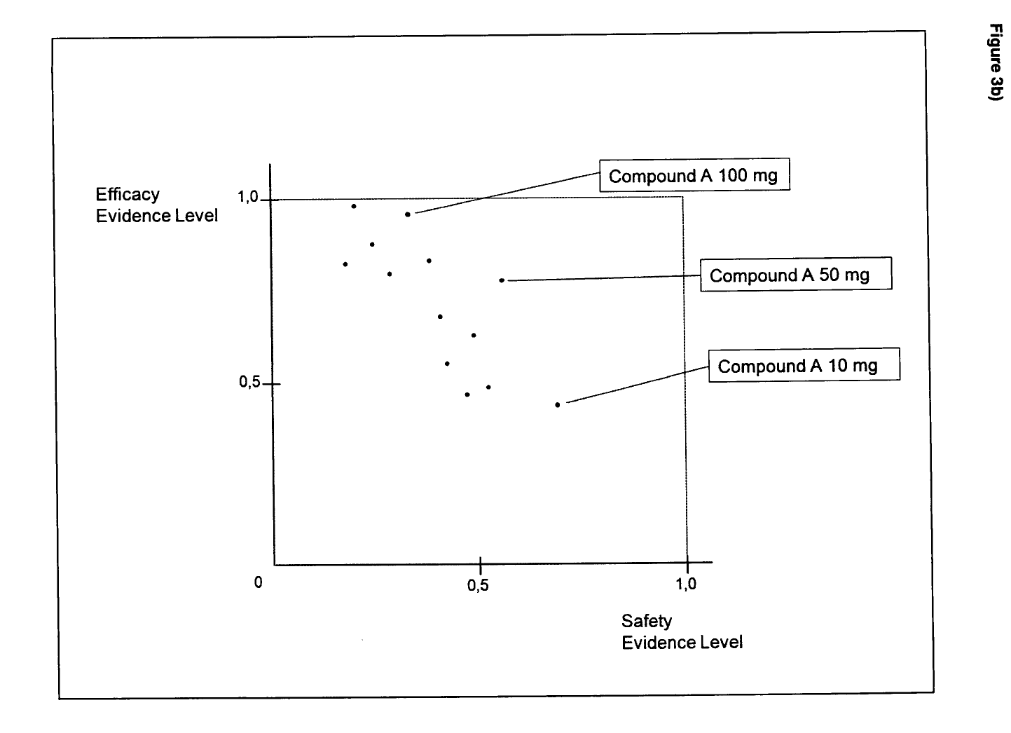

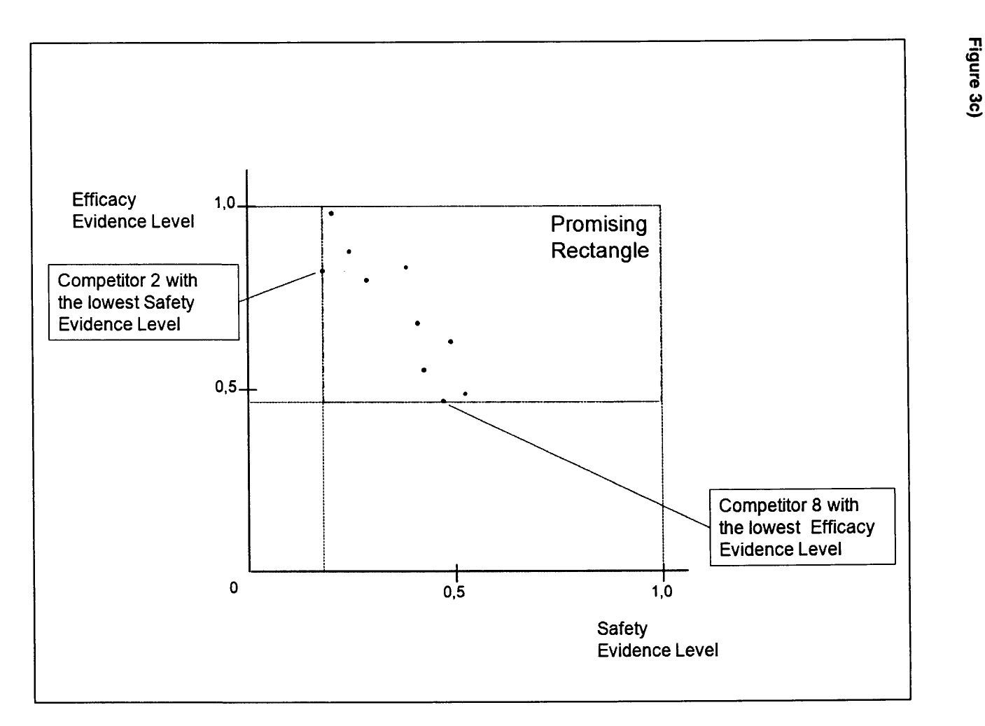

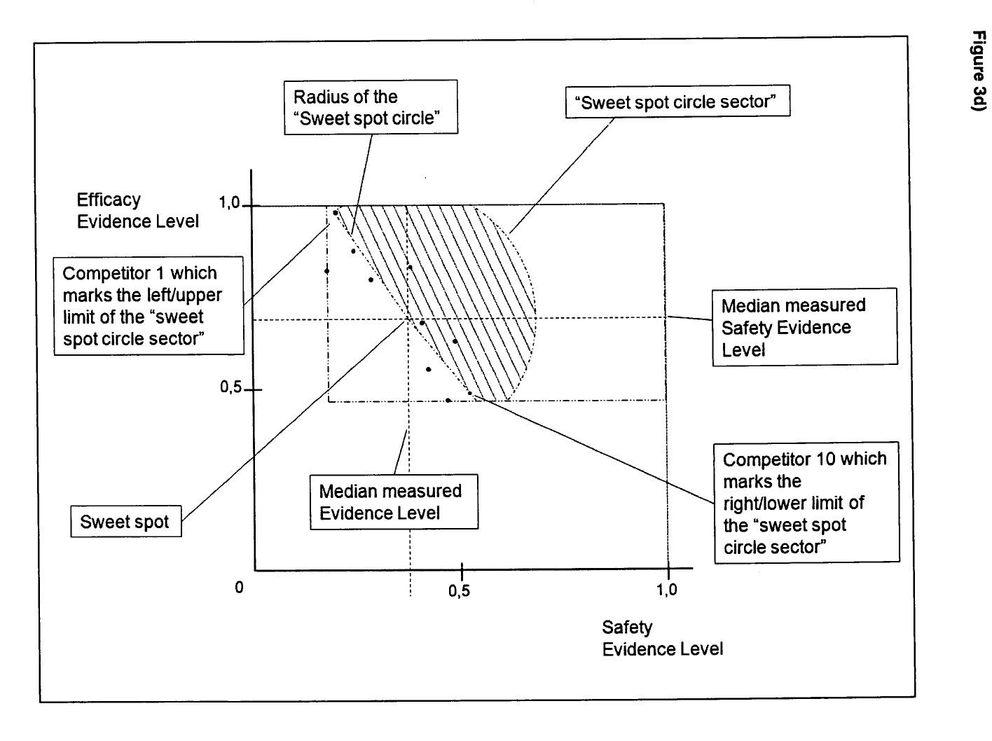

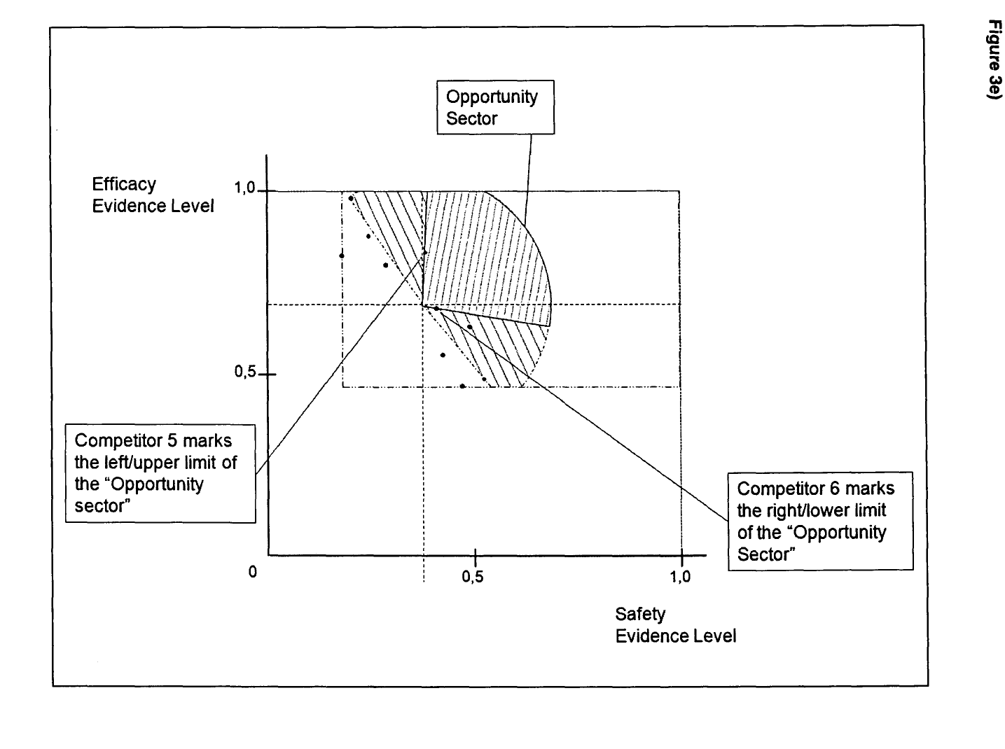

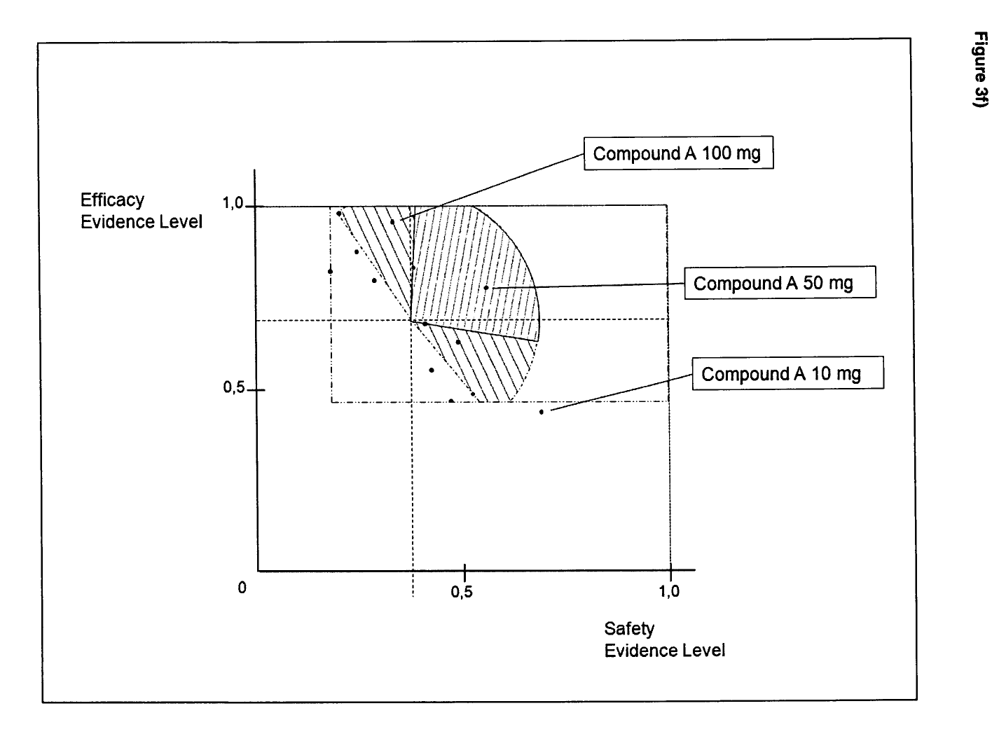

For indication I ten competitors have been already launched. In FIG. 3a) the calculated Safety and Efficacy Evidence Levels of 10 compounds are depicted as described in PCT Application PCT/EP2008/006480. Each dot represents one compound with a particular dosage and mode of application (e.g. intravenous application, oral application).

In comparison to Competitors 1-10 the safety/efficacy ratio of the 3 dosages of compound A are as follows in FIG. 3b).

Competitor 2 is the compound with the lowest Safety Evidence Level. Competitor 2 therefore marks the left limit of the promising rectangle (FIG. 3c)).

Competitor 8 is the compound with the lowest Efficacy Evidence Level. Competitor 8 therefore marks the lower limit of the promising rectangle.

The highest possible right and above limits of the promising rectangle are 1 (Safety and Efficacy Evidence Levels, respectively).

The resulting rectangle defines the “promising rectangle”.

In FIG. 3d) the crossing of the straight lines “Median Safety Evidence Level” and “Median Efficacy Evidence Level” marks the “sweet spot”. It is determined by the median Efficacy and Safety Evidence Level of the launched products 1-10 (median is defined according to http://en.wikipedia.org/w/index.php?title=Median&oldid=248520711; permanent link, accessed as of 31 Oct. 2008).

The “sweet spot” represents the “optimal” benefit/safety ratio in the market for the treatment of Indication I.

The radius of the “sweet spot circle sector” is based on the position of Competitor 1 which has the largest distance to the sweet spot and also serves for the upper/left limit of the sector. The upper/left limit of the sector is defined by Competitor 1, the lower/right limit of the “sweet spot circle” of the “sweet spot circle” is marked by Competitor 10. Please note: The “sweet spot circle sector” is additionally limited by the limits of the “promising rectangle” since in this particular case the compound should not be worse than the lowest Safety or Efficacy Evidence Level.

The sector between Competitor 5 and Competitor 6 of the “Sweet spot circle” is of particular interest: Competitor 5 marks the lower limit of the “Sweet spot circle sector” (no other compound has better safety) and Compound 6 the upper limit of the “Sweet spot circle sector” (no other compound has better efficacy). This sector represents a region within the “Sweet spot circle” where no other Competitor is located. This is the so-called “opportunity sector”. New compounds which fill in this sector are of particular market interests (FIG. 3e)).

The tree different dosages of Compound A are located in the principally possible locations within the coordinate system (FIG. 30):
1. Outside the “promising rectangle”
   (Compound A, 10 mg)
2. Inside the “promising rectangle” and inside the “opportunity sector” (Compound A, 50 mg)
3. Inside the “promising rectangle but outside the “opportunity sector” (Compound A, 100 Mg)

On the basis of the current analysis Compound A at a dosage of 50 mg had been selected as the Compound with an optimal benefit/risk ratio matching a potential market need.

### Example 4

### Proof of Concept—“Opportunity Sector Analysis” for a Compound Targeting an Autoimmune Disease

(Please note: The following example has been performed with publicly available original data for compounds which have been developed for an autoimmune disease. This can be considered as a practical proof of concept for the present patent application and PCT/EP2008/006480.)

In the autoimmune disease under evaluation some of the currently available therapies are highly efficacious (e.g. anti-TNFalpha). However, at the same time-point these compounds have severe side effects (e.g. due to immunosuppression). Classical anti-rheumatic treatments may have a better safety profile, but this is accompanied by lower efficacy.

The question is: What is the window for future compounds in a market with different compounds already launched.

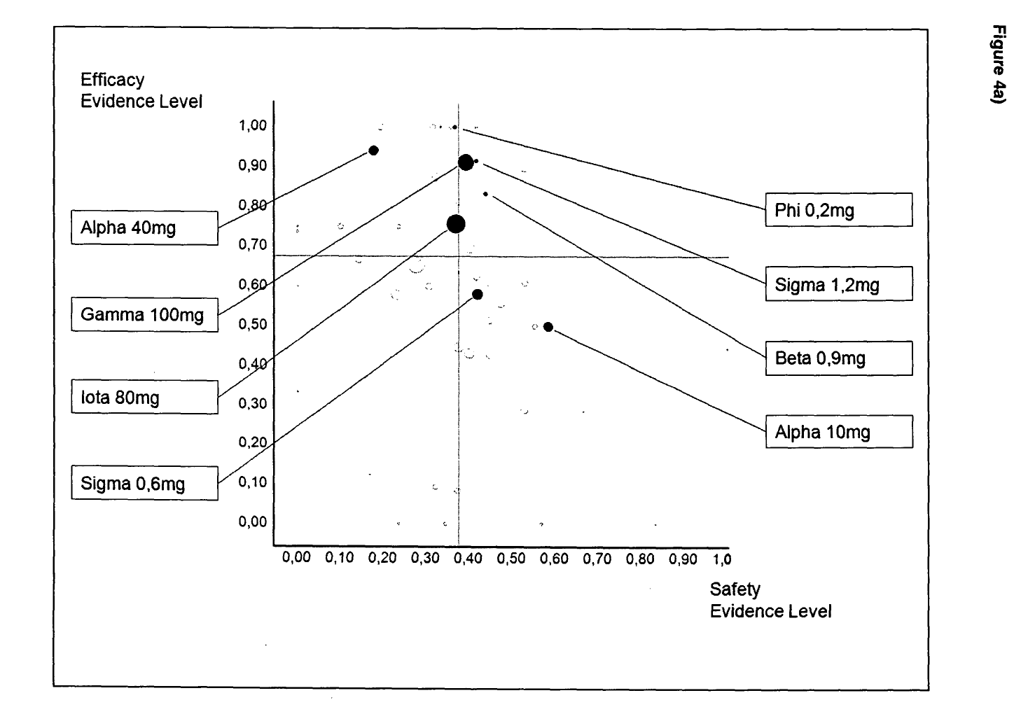

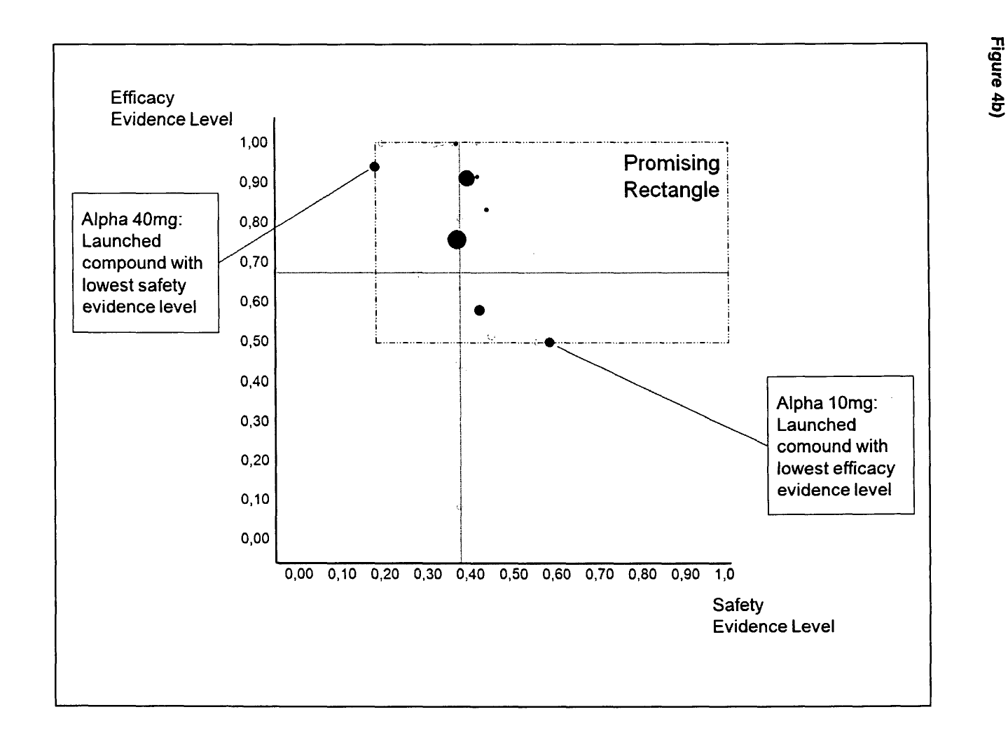

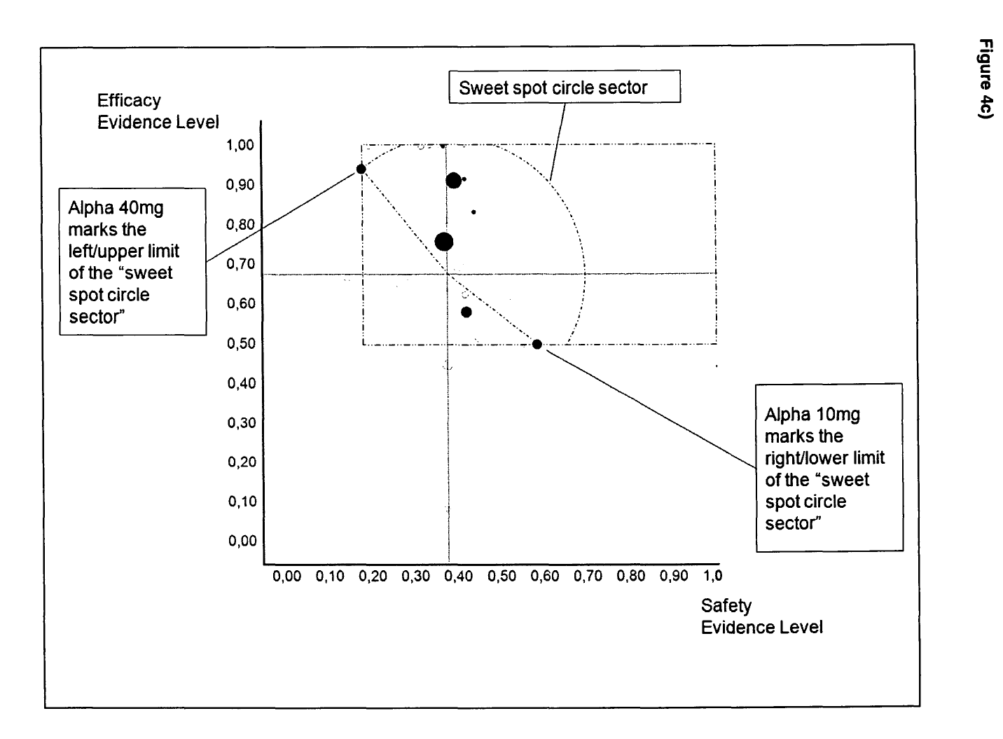

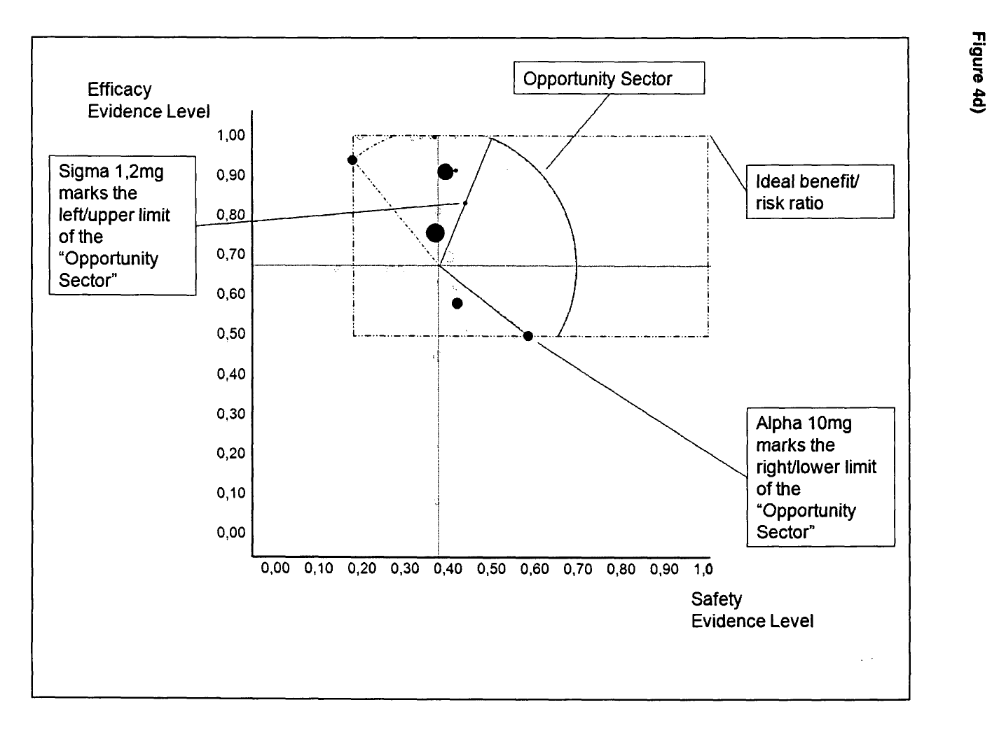

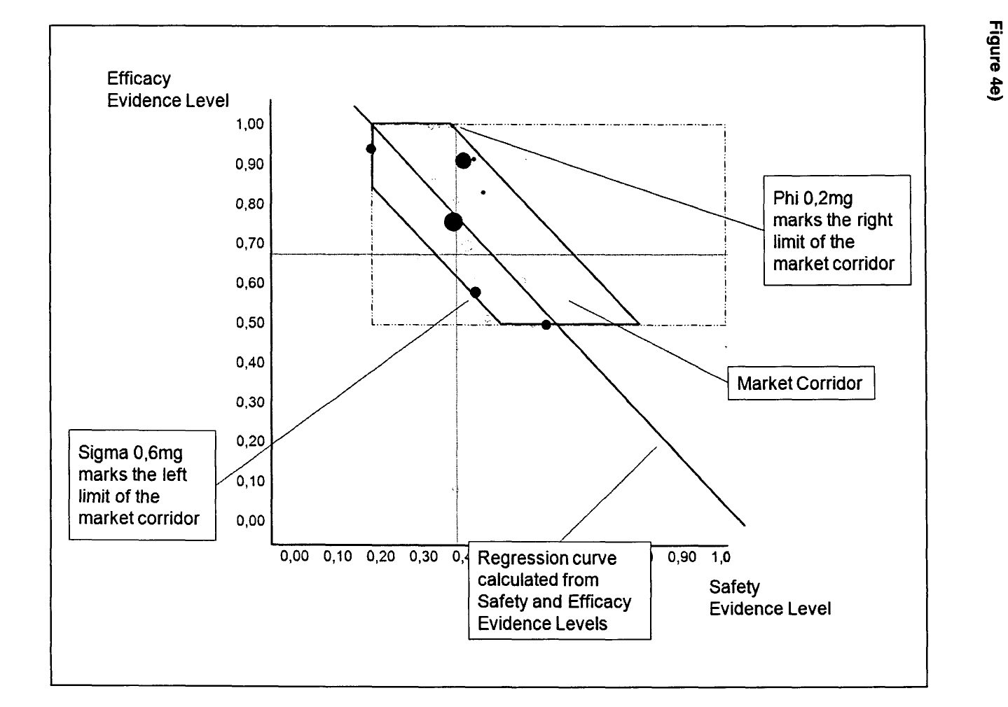

In FIG. 4a) (please see below) all launched products are displayed in black and not-launched compounds are displayed in grey. The size of the dots depends on number of endpoints that have been tested for a compound (the bigger the size of the circle the more endpoints have been evaluated to achieve the Evidence Level).

In FIG. 4b) the promising rectangle is drawn. The lower and the left limit are marked by the compounds with the lowest efficacy and safety Evidence Level, respectively.

In a next step the “sweet spot circle sector” is drawn. The diameter of the biggest sweet spot circle is defined by the launched compound which lies on the sweet circle with the largest diameter (compound with the highest efficacy or with the highest safety). The limits of the sweet spot circle sector are defined by the launched compounds with highest efficacy or safety (s. FIG. 4c).

In the last step of the “Opportunity Sector Analysis” the opportunity sector is drawn as part of the “sweet spot circle sector”. As described above the opportunity sector defines an area being the closest towards the ideal point and not including other compounds at the same time. Only launched compounds have been considered for the analysis.

The above analysis allows the following conclusions:
There seems to be a large opportunity window for compounds between “Alpha 10 mg” and “Sigma 1.2 mg”.
Interestingly, “Alpha 40 mg” and “Alpha 10 mg” are located at the different limits of the opportunity rectangle. Because of the above mentioned market opportunity defined by the “opportunity sector” one might consider to develop “Alpha” in an additional dosage between “Alpha 10 mg” and “Alpha 40 mg”.
Of course also other dosages above 10 mg might be feasible (e.g. 20 mg or 30 mg).

In addition, a “realistic corridor analysis” is performed. The “realistic corridor” reflects the interrelationship of Safety and Efficacy of a given disease. The “realistic corridor” is the area between two curves drawn parallel to the regression curve calculated from the Safety and Efficacy Evidence Levels of the compounds already launched (here in the automimmune disease under evaluation). Sigma 0.6 mg marks the left limit and Phi 0.2 marks the right limit of the X- and Y-values of the compounds. In addition, the “realistic corridor” is marked by the limits of the “promising quadrate”.

### Example 5

### Provision of an Anti-Flu Compound—Ranking of Tested Compounds

### Goal:

A Compound X for the treatment of flu has to be provided.

### Available Experimental Data:

The data of three different studies (here clinical trials) are available.

In these three trials four different compounds and Placebo as a control for treatment have been tested:
a) Compound X in the dosage of 5 mg per day (“5 mg”),
b) Compound X in the dosage of 10 mg per day (“10 mg”),
c) “Standard Therapy A”,
d) Compound Y, and
e) Placebo as a control

In each study arm only one compound was used. Thus the result of one study arm can be directly attributed to one particular compound (or a particular compound at a given dose). To obtain an analysis per one particular compound (at the same dose) multiple study arms will be combined in the analysis. Therefore, a comparison of different compounds is possible.

In patients four endpoints (i.e. endpoints of clinical trials) were measured:
i) Temperature (° C.),
ii) Leukocyte count (/μl),
iii) Erythrocyte sedimentation rate (mm/h), and
iv) C-reactive protein (mg/dl).

The results of the endpoints of the studies (mean value of a endpoint across all patients) are shown below.

In the present case not all compounds and not all endpoints were tested in all studies. Nevertheless the best compound for the treatment of flu can be provided as is shown below.

### Providing Study Results in a Table:

The data of clinical trials are considered to be the raw data for the further analyses.

Study results may represent different values (e.g. mean, median, absolute numbers), of a measured endpoint (e.g. temperature, leukocyte count, . . . ) of the patient population which participated in the particular study arm. In this example endpoints are used (i.e. mean values of respective endpoints measured in a collective of patients in the study).

In each study its study arms may be compared with each other. In this example only one compound is considered to be used in one study arm (i.e. the name of the study arm equals the name of the compound used) but also combination treatments in one study arm are possible to assess.

In this step for every study all endpoints are assigned or plotted against all compounds in this study (i.e. against the study arms). Alternatively one may provide tuples (i.e. a pair of values) of (endpoints/study arm) and combine any endpoint with any compound in a study. In this manner every compound is assigned to any endpoint in a study.

Study results study 1

| | Compound X | Standard | |
|---|---|---|---|
| Study arm/Endpoint | (10 mg) | Therapy A | Placebo |
| Temperature (° C.) | 37.4 | 38 | 38.3 |
| Leukocyte count (/μl) | 10300 | 14000 | 16000 |
| Erythrocyte sedimentation rate | 10 | 50 | 30 |
| (mm/h) | | | |

Study results study 2

| | Compound X | Compound | |
|---|---|---|---|
| Study arm/Endpoint | (10 mg) | X (5 mg) | Placebo |
| Temperature (° C.) | 37.8 | 38.3 | 39.0 |
| Leukocyte count (/μl) | 11000 | 13000 | 14500 |
| Erythrocyte sedimentation rate | 30 | 80 | 60 |
| (mm/h) | | | |
| C-reactive protein (mg/dl) | 9 | 5 | 7 |

Study results study 3

| Study arm/Endpoint | Compound Y | Placebo |
|---|---|---|
| Temperature (° C.) | 37.8 | 38.3 |
| Leukocyte count (/μl) | 11000 | 13000 |
| C-reactive protein (mg/dl) | 5 | 7 |

### Comparison of Results by Ranking Each Compound or Study Arm Along an Endpoint:

In this step for each study a ranking of the study arms along each endpoint is obtained by comparing endpoints of all study arms with each other.

In the present invention comparing of the endpoints of the study arms is performed by using a medically relevant evaluation of the endpoints. In other words: for each endpoint, the results leading to a better or worse rank of the study arm are predefined. The study arm with the best result is ranked “1”, i.e. its absolute rank, AR, is AR=1.

The results for all endpoints of the three studies are shown below.

Absolute Rank (AR) study 1

| Study arm/ | Compound | Standard | |
|---|---|---|---|
| Endpoint | X (10 mg) | Therapy A | Placebo |
| Temperature | 1 | 2 | 3 |
| (° C.) | | | |
| Leukocyte | 1 | 2 | 3 |
| count (/μl) | | | |
| Erythrocyte | 1 | 3 | 2 |
| sedimentation | | | |
| rate (mm/h) | | | |

Absolute Rank (AR) study 2

| Study arm/ | Compound | Compound | |
|---|---|---|---|
| Endpoint | X (10 mg) | X (5 mg) | Placebo |
| Temperature | 1 | 2 | 3 |
| (° C.) | | | |
| Leukocyte | 1 | 2 | 3 |
| count (/μl) | | | |
| Erythrocyte | 1 | 3 | 2 |
| sedimentation | | | |
| rate (mm/h) | | | |
| C-reactive | 3 | 1 | 2 |
| protein | | | |
| (mg/dl) | | | |

Absolute Rank (AR) study 3

| Study arm/ | | |
|---|---|---|
| Endpoint | Compound Y | Placebo |
| Temperature | 1 | 2 |
| (° C.) | | |
| Leukocyte | 1 | 2 |
| count (/μl) | | |
| C-reactive | 1 | 2 |
| protein | | |
| (mg/dl) | | |

### Examples for Ranking:

(1) In a patient with flu the C-reactive protein level, which measures inflammatory status of the body, as low as possible is optimal. Thus, the study arm with the lowest endpoint will be ranked best, i.e. “1”.

(2) In medicine often ranges are defined for endpoints which indicate normality, e.g. body temperature between 36.3° and 37.4° C. is considered to be normal. If a study arm is tested for the treatment of flu, a study arm with a lower endpoint of body temperature shall be ranked better than a study arm with higher endpoint of body temperature (this type of ranking is shown below in this example). However, if a study arm would be tested for the treatment of hypothermia a higher body temperature might indicate better efficacy and therefore be ranked better than a lower body temperature.

It may also be the case that an optimized value can be defined as a Temperature T which may be better than other Temperatures higher or lower in comparison thereto.

### Determining the Relative Rank RR Between all Study Arms in a Study:

In this step the relative rank for each study arm of one study in comparison to each other study arm in the same study is determined.

The relationship between two study arms is expressed by the “Relative Rank” (RR). RR is determined for each study arm along each endpoint. A study arm is assigned the RR=−1 in case of inferiority, RR=0 in case of equality, and RR=1 in case of superiority as compared to another study arm along that endpoint in the same study.

This procedure will be performed for each of the study arms with regards to each endpoint.

Relative Rank (RR) study 1

| | Comp. X | | Standard | Standard | | |
|---|---|---|---|---|---|---|
| | (10 mg) vs. | Comp. X | Therapy A | Therapy | Placebo vs. | Placebo |
| Study arms/ | Standard | (10 mg) vs. | vs. Comp. | A vs. | Comp. X | vs. St. |
| Endpoint | Therapy A | Placebo | X (10 mg) | Placebo | (10 mg) | Th. A |
| Temperature | 1 | 1 | −1 | 1 | −1 | −1 |
| (° C.) | | | | | | |
| Leukocyte | 1 | 1 | −1 | 1 | −1 | −1 |
| count (/μl) | | | | | | |
| Erythrocyte | 1 | 1 | −1 | −1 | −1 | 1 |
| sedimentation | | | | | | |
| rate (mm/h) | | | | | | |

Relative Rank (RR) study 2

| | Comp. X | | Comp. X | | | |
|---|---|---|---|---|---|---|
| | (10 mg) vs. | Comp. X | (5 mg) vs. | Comp. X | Placebo | Placebo |
| Study arms/ | Comp. X | (10 mg) vs. | Comp. X | (5 mg) vs. | vs. Comp. | vs. Comp. |
| Endpoint | (5 mg) | Placebo | (10 mg) | Placebo | X (10 mg) | X (5 mg) |
| Temperature | 1 | 1 | −1 | 1 | −1 | −1 |
| (° C.) | | | | | | |
| Leukocyte | 1 | 1 | −1 | 1 | −1 | −1 |
| count (/μl) | | | | | | |
| Erythrocyte | 1 | 1 | −1 | −1 | −1 | 1 |
| sedimentation | | | | | | |
| rate (mm/h) | | | | | | |
| C-reactive | −1 | −1 | 1 | 1 | 1 | −1 |
| protein | | | | | | |
| (mg/dl) | | | | | | |

Relative Rank (RR) study 3

| Study arms/ | Comp. Y vs. | Placebo vs. |
|---|---|---|
| Endpoint | Placebo | Comp. Y |
| Temperature (° C.) | 1 | −1 |
| Leukocyte count | 1 | −1 |
| (/μl) | | |
| C-reactive protein | 1 | −1 |
| (mg/dl) | | |

### Obtaining “Evidence Points” (EP):

In this step for each compound of one study, the superior RR values are summed up over all endpoints to so-called “Evidence Points” (EP). Thus the EP is the sum or number of all superior RRs.

Importantly, the EP is now assigned to the compound of the respective study arm.

Until here study arms have been compared, whereas now the EP are attributed to compounds, i.e. a member of a category of a study arm (e.g., compound, target).

Thus in the following the EP are accounted for the compound used in the respective study arms (this is also of importance in example 7). This is performed for each study separately. As is shown below only the “1” values (not the “−1” or “0” values) are summed up:

Evidence Points (EP) study 1

| | Comp. X | Standard | |
|---|---|---|---|
| Compound | (10 mg) | Therapy A | Placebo |
| EP | 6 | 2 | 1 |

Evidence Points (EP) study 2

| | Comp. X | Com. X | |
|---|---|---|---|
| Compound | (10 mg) | (5 mg) | Placebo |
| EP | 6 | 4 | 2 |

Evidence Points (EP) study 3

| Compound | Comp. Y | Placebo |
|---|---|---|
| EP | 3 | 0 |

Normalizing the “Evidence Points” (EP), thereby obtaining the “Evidence level” (EL):

In this step the “Evidence Level” (EL) is determined for each compound of a study.

To obtain the EL for each compound in a study, it's EP (i.e. the number of superior endpoints of a compound) is divided by Factor A, which is the product of the number of endpoints multiplied with the difference number of compounds minus 1.

In study 1 of the present example

EL=EP/(3*(3−1));A=(3*(3−1));

In study 2 of the present example

EL=EP/(4*(3−1))A=(4*(3−1));

In study 3 of the present example

EL=EP/(3*(2−1))A=(3*(2−1));

The results are shown below.

Evidence Level (EL) study 1

| Compound | Compound X (10 mg) | Standard Therapy A | Placebo |
|---|---|---|---|
| EL | 6/6 = 1.0 | 2/6 = 0.33 | 1/6 = 0.17 |

Evidence Level (EL) study 2

| Compound | Compound X (10 mg) | Compound X (5 mg) | Placebo |
|---|---|---|---|
| EL | 6/8 = 0.75 | 4/8 = 0.5 | 2/8 = 0.25 |

Evidence Level (EL) study 3

| Compound | Compound Y | Placebo |
|---|---|---|
| EL | 3/3 = 1.0 | 0/3 = 0 |

### Comparing the Compounds Over all Studies:

In this step for each compound its “overall EL value (ELₛᵤₘ)” over all studies is determined.

To obtain the ELₛᵤₘ for each compound over all studies, its EPₛᵤₘ (i.e. the sum of all EP values of a compound over all studies) is divided by the sum of Factors A over all studies in which the compound is involved.

The EL and the Elₛᵤₘ values obtained for each study allow for the comparison of the different compounds over all available data, i.e. in the present case the data derived from the three different studies.

Therefore, the approach allows putting compounds into relation which have not been tested in the same study so-far.

Summing up all evidence levels results in overall EL values (ELₛᵤₘ) as follows:

Evidence Level (ELₛᵤₘ) per compound across all studies

| | | | |
|---|---|---|---|
| Compound Y | ELₛᵤₘ(CY) | 3/3 = 1.0 | 1.0 |
| Compound X (10 mg) | ELₛᵤₘ (CX10) | 12/14 = 0.86 | 0.86 |
| Compound X (5 mg) | ELₛᵤₘ (CX5) | 4/8 = 0.5 | 0.5 |
| Standard Therapy A | ELₛᵤₘ (StA) | 2/6 = 0.33 | 0.33 |
| Placebo | ELₛᵤₘ (P) | 3/17 = 0.18 | 0.18 |

### Example 6

### Provision of an Anti-Flu Compound—Improved Ranking of Tested Compounds

To achieve an improved ranking of all compounds, for each comparison of two compounds, the RR of one compound (i.e. the first compound in the comparison) the RR will be multiplied with the formerly calculated evidence level EL of the second compound to obtain a so-called “Comparator Adjusted Relative Rank” (CA-RR) of the first compound.

### Introducing Weighting Factors:

### Goal:

The quality of the rating of the respective “comparator compound” has to be considered.

### Strategy:

The quantitatively calculated ELₛᵤₘ to assess the relation (i.e. superiority or inferiority with regard to its effects) of compounds (see Example 1) will be supplemented by a factor taking the evidence level of the compounds into account with which a compound under evaluation is compared with.

This is justified by the fact, that there has to be made a difference between a situation where a compound is only compared with a placebo and a situation where a compound is compared with a potent comparator compound.

To achieve this, for each comparison of two compounds, for the first compound the RR will be multiplied with the formerly calculated Summarized Evidence Level (ELₛᵤₘ) of the second compound to obtain a “Comparator Adjusted Relative Rank” (CA-RR) of the first compound.

In the example mentioned above the results are as follows:

Comparator Adjusted Relative Rank (CA-RR) study 1

| | Compound | | Standard | | | |
|---|---|---|---|---|---|---|
| | X (10 mg) | | Therapy A | Standard | Placebo | |
| | vs. | Compound X | vs. | Therapy | vs. | Placebo vs. |
| Compound/ | Standard | (10 mg) vs. | Compound X | A vs. | Compound X | Standard |
| Endpoint | Therapy A | Placebo | (10 mg) | Placebo | (10 mg) | Therapy A |
| Temperature | 1 × 0.33 = | 1 × 0.18 = | −1 × 0.86 = | 1 × 0.18 = | −1 × 0.86 = | −1 × 0.33 = |
| (° C.) | 0.33 | 0.18 | −0.86 | 0.18 | −0.86 | −0.33 |
| Leukocyte | 1 × 0.33 = | 1 × 0.18 = | −1 × 0.86 = | 1 × 0.18 = | −1 × 0.86 = | −1 × 0.33 = |
| count (/μl) | 0.33 | 0.18 | −0.86 | 0.18 | −0.86 | −0.33 |
| Erythrocyte | 1 × 0.33 = | 1 × 0.18 = | −1 × 0.86 = | −1 × 0.18 = | −1 × 0.86 = | 1 × 0.33 = |
| sedimentation | 0.33 | 0.18 | −0.86 | −0.18 | −0.86 | 0.33 |
| rate (mm/h) | | | | | | |

Comparator Adjusted Relative Rank (CA-RR) study 2

| | Comp. X | | Comp. X | | | Placebo |
|---|---|---|---|---|---|---|
| | (10 mg) vs. | Comp. X | (5 mg) vs. | Comp. X | Placebo | vs. |
| Compound/ | Com. X | (10 mg) vs. | Comp. X | (5 mg) vs. | vs. Comp. | Comp. X |
| Endpoint | (5 mg) | Placebo | (10 mg) | Placebo | X (10 mg) | (5 mg) |
| Temperature | 1 × 0.5 = | 1 × 0.18 = | −1 × 0.86 = | 1 × 0.18 = | −1 × 0.86 = | −1 × 0.5 = |
| (° C.) | 0.5 | 0.18 | −0.86 | 0.18 | −0.86 | −0.5 |
| Leukocyte | 1 × 0.5 = | 1 × 0.18 = | −1 × 0.86 = | 1 × 0.18 = | −1 × 0.86 = | −1 × 0.5 = |
| count (/μl) | 0.5 | 0.18 | −0.86 | 0.18 | −0.86 | −0.5 |
| Erythrocyte | 1 × 0.5 = | 1 × 0.18 = | −1 × 0.86 = | −1 × 0.18 = | −1 × 0.86 = | 1 × 0.5 = |
| sedimentation | 0.5 | 0.18 | −0.86 | −0.18 | −0.86 | 0.5 |
| rate (mm/h) | | | | | | |
| C-reactive | −1 × 0.5 = −0.5 | −1 × 0.18 = | 1 × 0.86 = | 1 × 0.18 = | 1 × 0.86 = | −1 × 0.5 = |
| protein | | −0.18 | 0.86 | 0.18 | 0.86 | −0.5 |
| (mg/dl) | | | | | | |

Comparator Adjusted Relative Rank (CA-RR) study 3

| Compound/ | Comp. Y vs. | |
|---|---|---|
| Endpoint | Placebo | Placebo vs. Comp. Y |
| Temperature | 1 × 0.18 = 0.18 | −1 × 1.0 = −1.0 |
| (° C.) | | |
| Leukocyte | 1 × 0.18 = 0.18 | −1 × 1.0 = −1.0 |
| count (/μl) | | |
| C-reactive | 1 × 0.18 = 0.18 | −1 × 1.0 = −1.0 |
| protein | | |
| (mg/dl) | | |

The result of the “Comparator Adjusted Evidence Levels” (CA-EL) is calculated analogously to the EL incorporating the ELₛᵤₘ of the respective comparator:

Comparator Adjusted Evidence Level (CA-EL) per compound study 1

| Compound X (10 mg) | Standard Therapy A | Placebo |
|---|---|---|
| (3 × 0.33 + 3 × 0.18)/ | (0 × 0.86 + 2 × 0.18)/ | 1 × 0.33/(3 × 0.86 + |
| (3 × 0.33 + 3 × 0.18) = | (3 × 0.86 + 3 × 0.18) = | 3 × 0.33) = 0.09 |
| 1.0 | 0.12 | |

Comparator Adjusted Evidence Level (EL) per compound study 2

| Compound X (10 mg) | Compound X (5 mg) | Placebo |
|---|---|---|
| (3 × 0.5 + 3 × 0.18)/ | (1 × 0.86 + 3 × 0.18)/ | (1 × 0.86 + 1 × 0.5)/ |
| (4 × 0.5 + 4 × 0.18) = | (4 × 0.86 + 4 × 0.18) = | (4 × 0.86 + 4 × 0.5) = |
| 0.75 | 0.34 | 0.25 |

Comparator Adjusted Evidence Level (EL) per compound study 3

| Compound Y | Placebo |
|---|---|
| (3 × 0.18)/(3 × 0.18) = 1.0 | (0 × 1.0)/(3 × 1.0) = 0 |

Aggregation of CA-EL results in a Summarized Comparator Adjusted EL (CA-ELₛᵤₘ) as follows:

Calculation: Summarized Comparator Adjusted Evidence
Level per compound (CA-ELₛᵤₘ)

| | |
|---|---|
| Compound Y | (3 × EL_{P})/(3 × EL_{P}) |
| Compound X | ((3 × EL_{StA} + 3 × E_{LP}) + (3 × EL_{CX5} + 3 × EL_{P}))/ |
| (10 mg) | ((3 × EL_{StA} + 3 × EL_{P}) + (4 × EL_{CX5} + 4 × EL_{P})) |
| Compound X | (1 × EL_{CX10} + 3 × EL_{P})/(4 × EL_{CX10} + 4 × EL_{P}) |
| (5 mg) | |
| Standard Therapy A | (0 EL_{CX10} + 2 × EL_{P})/(3 × EL_{CX10} + 3 × EL_{P}) |
| Placebo | ((0 × EL_{CX10} + 1 × EL_{StA}) + (1 × EL_{CX10} + |
| | 1 × EL_{CX5}) + (0 × EL_{CY}))/ |
| | ((3 × EL_{CX10} + 3 × EL_{StA}) + (4 × EL_{CX10} + 4 × |
| | EL_{CX5}) + (3 × EL_{CY})) |

Summarized Comparator Adjusted Evidence Level per compound (CA-ELₛᵤₘ)

| | | Results | CA- | |
|---|---|---|---|---|
| | Calculation | CA-EL | ELₛᵤₘ | ELₛᵤₘ |
| Comp. Y | (3 × 0.18) Study 3/(3 × 0.18) Study 3 | 0.54/0.54 | 1.0 | 1.0 |
| Comp. X | ((3 × 0.33 + 3 × 0.18) Study 1 + (3 × 0.5 + 3 × | 3.57/4.25 | 0.84 | 0.86 |
| (10 mg) | 0.18) Study 2)/ | | | |
| | ((3 × 0.33 + 3 × 0.18) Study 1 + (4 × 0.5 + 4 × | | | |
| | 0.18) Study 2) | | | |
| Comp. | (1 × 0.86 + 3 × 0.18) Study 2/(4 × 0.86 + 4 × | 1.4/4.16 | 0.34 | 0.5 |
| X (5 mg) | 0.18) Study 2 | | | |
| St. Th. A | (0 × 0.86 + 2 × 0.18) Study 1/(3 × 0.86 + 3 × | 0.36/3.12 | 0.12 | 0.33 |
| | 0.18) Study 1 | | | |
| Placebo | ((0 × 0.86 + 1 × 0.33) Study 1 + (1 × 0.86 + 1 × | 1.69/12.01 | 0.14 | 0.18 |
| | 0.5) Study 2 + (0 × 1.0) Study 3)/ | | | |
| | ((3 × 0.86 + 3 × 0.33) Study 1 + (4 × 0.86 + 4 × | | | |
| | 0.5) St. 2 + (3 × 1.0) Study 3) | | | |

As mentioned above, the summarized Evidence Level (ELₛᵤₘ) across all studies delivers the following ranking: Compound Y, Compound X 10 mg, Compound X 5 mg, Standard Therapy A, Placebo. Interestingly, the ranking is slightly different, if the summarized Comparator Adjusted Evidence Level (CA-ELₛᵤₘ) is performed: Compound Y, Compound X 10 mg, Compound X 5 mg, Placebo, Standard therapy.

1-15. (canceled)

16. A method for evaluating one or more candidate compounds and/or using a candidate compound, the method comprising:
a) constructing and displaying a Cartesian x-y coordinate-system;
b) accessing a dataset of a number of compounds stored in a data base, which dataset comprises a class of compounds and two values x and y assigned to each compound, wherein x is a first Evidence Level, and y is a second Evidence Level;
c) placing and displaying data points P(x/y) into the coordinate-system using the dataset of b), wherein each data point P(x/y) is assigned to a corresponding compound of the number of compounds in the dataset and is obtained using the x and y values assigned to the corresponding compound as x, y coordinates in the x-y coordinate-system;
d) determining a “promising rectangle” using at least one data point from the data points P(x/y) in c) and a predetermined criteria, and displaying the “promising rectangle” in the x-y coordinate-system;
e) determining a “sweet spot” using a predefined relation among the data points P(x/y) in c) and displaying the “sweet spot” in the x-y coordinate-system;
f) determining a “sweet spot circle” centered in the “sweet spot” and having a desired radius that is determined based on the data points P(x/y) in c), and displaying the “sweet spot circle” in the x-y coordinate-system;
g) optionally determining a “sweet spot circle sector” using the points P(x/y) in c), the “promising rectangle” determined in d), the “sweet spot” determined in e), and the “sweet spot circle” determined in f) and displaying the “sweet spot circle sector” in the x-y coordinate-system, wherein the “sweet spot circle sector” is an area obtained by determining a sector of the “sweet spot circle”, which is limited by 1) a first straight line drawn through the “sweet spot” and a point of a first compound with a maximum value of x, 2) a second straight line drawn through the “sweet spot” and a point of a second compound with a maximum value of y and 3) an interior of the “promising rectangle”;
h) determining an “opportunity sector” using the points P in c), the “promising rectangle” determined in d), the “sweet spot” determined in e), and the “sweet spot circle” determined in f) and displaying the “opportunity sector” in the x-y coordinate-system, wherein the “opportunity sector” is the area obtained by determining a sector of the “sweet spot circle”, which is limited by two straight lines drawn through the “sweet spot” and two data points P(x/y) so that the obtained sector does not comprise more than two data points P(x/y) and the sector is intersected by a straight line drawn through the “sweet spot” and a point M (1;1) with the Coordinates x=y=1 and is the sector closest to M(1;1);
i) inputting data points of one or more candidates compounds and placing the inputted data points into the x-y coordinate system; and
j) evaluating the one or more candidate compounds by identifying positions of their data points relative to the “promising rectangle”, the “sweet spot circle” and/or the “opportunity sector” in the x-y coordinate-system.

17. The method according to claim 16, further comprising:
k) localizing a candidate compound's data point that is within the “opportunity sector” and selecting said candidate compound.

18. The method according to claim 16, further comprising:
k) localizing a candidate compound's data point that is inside the promising rectangle and inside the sweet spot circle sector and selecting said candidate compound.

19. The method according to claim 16, further comprising identifying and/or providing a candidate compound suitable for treating a patient based on a)-j).

20. The method according to claim 16, further comprising:
determining an optimal dosage for a selected candidate compound taking into account market factors and based on a)-j);
selecting the selected candidate compound based on a)-j), wherein the class of compounds set forth in b) comprises compounds which are the same as the selected candidate compound but in different concentrations.

21. The method according to claim 16, further comprising:
comparing and evaluating different dosages of a selected candidate compound based on a)-j);
selecting the selected candidate compound based on a)-j), wherein the class of compounds set forth in b) comprises compounds which are the same as the selected candidate compound but in different concentrations.

22. The method according to claim 16, further comprising:
comparing and evaluating different administration modes of a selected candidate compound such as administration via infusion, intramuscular administration, oral administration based on a)-j);
selecting the selected candidate compound based on a)-j), wherein the selected candidate compound is a compound with a particular mode of administration and the class of compounds set forth in b) comprises compounds which are the same as the selected candidate compound but in different modes of administration.

23. The method according to claim 16, wherein in step d) the predetermined criteria for determining said “promising rectangle” is established by determining:
d1) the point with the maximum value of x and a point with a minimum value x value;
d2) the point with the maximum value of y and a point with a minimum value of y; and
d3) drawing two straight lines in parallel to an x-axis of the x-y coordinate system through the points obtained in d1) and two straight lines in parallel to a y-axis through the points obtained in d2), thereby constructing a rectangle;
wherein the “sweet spot” is a point with the median value of x and the median value of y over all compounds obtained in c); and the radius of the “sweet spot circle” is a maximum distance of all distances between the point of the “sweet spot” and each data point P(x/y).

24. The method according to claim 23, further comprising:
k) localizing a candidate compound's data point that is within the “opportunity sector” and selecting said candidate compound.

18. The method according to claim 16, further comprising:
k) localizing a candidate compound's data point that is inside the promising rectangle and inside the sweet spot circle sector and selecting said candidate compound.

25. The method according to claim 23, further comprising identifying and/or providing a candidate compound suitable for treating a patient based on a)-j).

26. The method according to claim 23, further comprising:
determining an optimal dosage for a selected candidate compound taking into account market factors and based on a)-j);
selecting the selected candidate compound based on a)-j), wherein the class of compounds set forth in b) comprises compounds which are the same as the selected candidate compound but in different concentrations.

27. The method according to claim 23, further comprising:
comparing and evaluating different dosages of a selected candidate compound based on a)-j);
selecting the selected candidate compound based on a)-j), wherein the class of compounds set forth in b) comprises compounds which are the same as the selected candidate compound but in different concentrations.

28. The method according to claim 23, further comprising:
comparing and evaluating different administration modes of a selected candidate compound such as administration via infusion, intramuscular administration, oral administration based on a)-j);
selecting the selected candidate compound based on a)-j), wherein the selected candidate compound is a compound with a particular mode of administration and the class of compounds set forth in b) comprises compounds which are the same as the selected candidate compound but in different modes of administration.

29. A method for comparing and evaluating a candidate compound in a class of compounds or entities, the method comprising:
a) placing a data point for a number of compounds into a Cartesian x-y coordinate system, wherein x is a first Evidence Level and y is a second Evidence Level, each data point represents a point P(xₚ/yₚ) in the x-y coordinate system, and each xₚ and each yₚ is an Evidence Level of a compound P of the number of compounds;
b) defining a “promising rectangle” in the x-y coordinate system;
c) defining a “sweet spot” in the x-y coordinate system;
d) defining a “sweet spot circle” in the coordinate-system;
e) optionally defining a “sweet spot circle sector” in the x-y coordinate system;
f) defining an “opportunity sector” in the x-y coordinate system;
g) placing the data point for the candidate compound into the x-y coordinate system;
h) evaluating the candidate compound by identifying a position of a respective data point relative to the “promising rectangle”, the “sweet spot circle” and/or the “opportunity sector” in the x-y coordinate system; and
i) optionally performing a “realistic corridor analysis” by drawing a regression curve, drawing two parallels to the regression curve and evaluating compounds lying between limits of the two parallels and limits of the “promising rectangle”.

30. The method according to claim 29, further comprising identifying and/or providing a candidate compound suitable for treating a patient based on a)-i).

31. The method according to claim 29, further comprising: selecting a compound based on a)-i); and
preparing a pharmaceutical composition based on the selected compound.

32. The method according to claim 29, further comprising: selecting a compound based on a)-i); and
using the selected compound for pharmaceutical purposes.

33. Use of the determination of an opportunity sector for identifying
a. a compound suitable for the further development of a given medical indication,
b. an optimal dosage for a given compound,
c. the best mode of administration of a given compound,
d. the selection of the best indication of a given compound, or
e. the most promising compound in animal experiments to be further developed in clinical trials.

34. A method for obtaining a ranking of compounds suitable for use in an intended pharmaceutical application, the method comprising:
a) accessing data from a database comprising data of at least two studies, wherein in each of the at least two studies all endpoints data are assigned all compounds;
b) optionally using the data accessed in a) and comparing the data of each compound in one of the at least two studies with those of each other compound in the one of the at least studies along of all endpoints determined;
c) using the data in a) or b) and obtaining for each endpoint in a study an absolute ranking, AR, of the compounds, wherein an AR ranking of 1 is assigned to the best compound for a particular endpoint of a study, the second best compound is assigned an AR ranking of 2, the third best compound and AR ranking of 3 and saving the AR ranking of each compound and endpoint;
d) using the data obtained in a) to c) and determining a relative rank, RR, for each compound in comparison to each other compound along each endpoint in the same study, wherein for each compound an RR rank of −1 is assigned in case of inferiority, an RR rank of 0 is assigned in case of equality, and an RR rank of 1 is assigned in case of superiority as compared to the other compound in the same study; saving the RR rank for each pair of compounds;
e) using the data obtained in a) to d) and determining “Evidence Points” (EP) for each compound of one study, wherein for each compound the superior RR rank values of 1 over all endpoints are summed up to obtain the EP, which is the sum of all superior RRs for a compound in a study; saving the EP for each compound in a study;
f) using the data obtained in a) to e) and determining the “Evidence Level” (EL) for each compound of a study, wherein for each compound in a study, its EP, i.e. the number of superior endpoints of a compound, is divided by Factor A, wherein Factor A is a product of a number of endpoints multiplied with a difference of the number of compounds included in the study minus 1; saving the EL for each compound in a study;
g) using the data obtained in a) to f) and determining the “overall EL value (ELₛᵤₘ)” for each compound over all studies, wherein in order to obtain the ELₛᵤₘ for each compound over all studies, its EPₛᵤₘ, i.e. the sum of all EP values of a compound over all studies, is divided by the sum of factors A over all studies in which the compound is involved; saving the ELₛᵤₘ for each compound;
h) optionally using the data obtained in a) to g) and introducing a weighing factor CA, which is multiplied with the RR value of a compound in order to obtain a “Comparator Adjusted Relative Rank”, CA-RR, wherein CA of each compound is the formerly calculated overall EL value (ELₛᵤₘ) of the compound in comparison to which the RR value is determined, wherein step d) is reiterated and in reiterated step d) CA-RR replaces the RR for each compound of one study in comparison to each other compound along each endpoint in the same study and steps e) to g) are reiterated in order to determine a Summarized Comparator Adjusted EL (CA-ELₛᵤₘ), which is obtained by performing steps e) to g) upon replacing RR by CA-RR; saving the CA-ELₛᵤₘ for each compound;
i) optionally using the data obtained in a) to g) or a) to h) and ranking all compounds along the values ELₛᵤₘ or CA-ELₛᵤₘ; and
j) optionally determining a best compound for an indented pharmaceutical application, which is the compound with the best value ELₛᵤₘ or CA-ELₛᵤₘ.

35. A computer system comprising a structure for performing the following method:
a) constructing and displaying a Cartesian x-y coordinate-system;
b) accessing a dataset of a number of compounds stored in a data base, which dataset comprises a class of compounds and two values x and y assigned to each compound, wherein x is a first Evidence Level, and y is a second Evidence Level;
c) placing and displaying data points P(x/y) into the coordinate-system using the dataset of b), wherein each data point P(x/y) is assigned to a corresponding compound of the number of compounds in the dataset and is obtained using the x and y values assigned to the corresponding compound as x, y coordinates in the x-y coordinate-system;
d) determining a “promising rectangle” using at least one data point from the data points P(x/y) in c) and a predetermined criteria, and displaying the “promising rectangle” in the x-y coordinate-system;
e) determining a “sweet spot” using a predefined relation among the data points P(x/y) in c) and displaying the “sweet spot” in the x-y coordinate-system;
f) determining a “sweet spot circle” centered in the “sweet spot” and having a desired radius that is determined based on the data points P(x/y) in c), and displaying the “sweet spot circle” in the x-y coordinate-system;
g) optionally determining a “sweet spot circle sector” using the points P(x/y) in c), the “promising rectangle” determined in d), the “sweet spot” determined in e), and the “sweet spot circle” determined in f) and displaying the “sweet spot circle sector” in the x-y coordinate-system, wherein the “sweet spot circle sector” is an area obtained by determining a sector of the “sweet spot circle”, which is limited by 1) a first straight line drawn through the “sweet spot” and a point of a first compound with a maximum value of x, 2) a second straight line drawn through the “sweet spot” and a point of a second compound with a maximum value of y and 3) an interior of the “promising rectangle”;
h) determining an “opportunity sector” using the points P in c), the “promising rectangle” determined in d), the “sweet spot” determined in e), and the “sweet spot circle” determined in f) and displaying the “opportunity sector” in the x-y coordinate-system, wherein the “opportunity sector” is the area obtained by determining a sector of the “sweet spot circle”, which is limited by two straight lines drawn through the “sweet spot” and two data points P(x/y) so that the obtained sector does not comprise more than two data points P(x/y) and the sector is intersected by a straight line drawn through the “sweet spot” and a point M (1;1) with the Coordinates x=y=1 and is the sector closest to M(1;1);
i) inputting data points of one or more candidates compounds and placing the inputted data points into the x-y coordinate system; and
j) evaluating the one or more candidate compounds by identifying positions of their data points relative to the “promising rectangle”, the “sweet spot circle” and/or the “opportunity sector” in the x-y coordinate-system.

36. The computer system of claim 35, wherein in the method performed by the computer system the predetermined criteria for determining said “promising rectangle” in step d) is established by determining:
d1) the point with the maximum value of x and a point with a minimum value x value;
d2) the point with the maximum value of y and a point with a minimum value of y; and
d3) drawing two straight lines in parallel to an x-axis of the x-y coordinate system through the points obtained in d1) and two straight lines in parallel to a y-axis through the points obtained in d2), thereby constructing a rectangle;
wherein the “sweet spot” is a point with the median value of x and the median value of y over all compounds obtained in c); and the radius of the “sweet spot circle” is a maximum distance of all distances between the point of the “sweet spot” and each data point P(x/y).

37. A computer system comprising a structure for performing the following method:
a) placing a data point for a number of compounds into a Cartesian x-y coordinate system, wherein x is a first Evidence Level and y is a second Evidence Level, each data point represents a point P(xₚ/yₚ) in the x-y coordinate system, and each xₚ and each yₚ is an Evidence Level of a compound P of the number of compounds;
b) defining a “promising rectangle” in the x-y coordinate system;
c) defining a “sweet spot” in the x-y coordinate system;
d) defining a “sweet spot circle” in the coordinate-system;
e) optionally defining a “sweet spot circle sector” in the x-y coordinate system;
f) defining an “opportunity sector” in the x-y coordinate system;
g) placing the data point for the candidate compound into the x-y coordinate system;
h) evaluating the candidate compound by identifying a position of a respective data point relative to the “promising rectangle”, the “sweet spot circle” and/or the “opportunity sector” in the x-y coordinate system; and
i) optionally performing a “realistic corridor analysis” by drawing a regression curve, drawing two parallels to the regression curve and evaluating compounds lying between limits of the two parallels and limits of the “promising rectangle”.

38. A computer system comprising a structure for performing the following method:
a) accessing data from a database comprising data of at least two studies, wherein in each of the at least two studies all endpoints data are assigned all compounds;
b) optionally using the data accessed in a) and comparing the data of each compound in one of the at least two studies with those of each other compound in the one of the at least studies along of all endpoints determined;
c) using the data in a) or b) and obtaining for each endpoint in a study an absolute ranking, AR, of the compounds, wherein an AR ranking of 1 is assigned to the best compound for a particular endpoint of a study, the second best compound is assigned an AR ranking of 2, the third best compound and AR ranking of 3 and saving the AR ranking of each compound and endpoint;
d) using the data obtained in a) to c) and determining a relative rank, RR, for each compound in comparison to each other compound along each endpoint in the same study, wherein for each compound an RR rank of −1 is assigned in case of inferiority, an RR rank of 0 is assigned in case of equality, and an RR rank of 1 is assigned in case of superiority as compared to the other compound in the same study; saving the RR rank for each pair of compounds;
e) using the data obtained in a) to d) and determining “Evidence Points” (EP) for each compound of one study, wherein for each compound the superior RR rank values of 1 over all endpoints are summed up to obtain the EP, which is the sum of all superior RRs for a compound in a study; saving the EP for each compound in a study;
f) using the data obtained in a) to e) and determining the “Evidence Level” (EL) for each compound of a study, wherein for each compound in a study, its EP, i.e. the number of superior endpoints of a compound, is divided by Factor A, wherein Factor A is a product of a number of endpoints multiplied with a difference of the number of compounds included in the study minus 1; saving the EL for each compound in a study;
g) using the data obtained in a) to f) and determining the “overall EL value (ELₛᵤₘ)” for each compound over all studies, wherein in order to obtain the ELₛᵤₘ for each compound over all studies, its EPₛᵤₘ, i.e. the sum of all EP values of a compound over all studies, is divided by the sum of factors A over all studies in which the compound is involved; saving the ELₛᵤₘ for each compound;
h) optionally using the data obtained in a) to g) and introducing a weighing factor CA, which is multiplied with the RR value of a compound in order to obtain a “Comparator Adjusted Relative Rank”, CA-RR, wherein CA of each compound is the formerly calculated Summarized Evidence Level (ELₛᵤₘ) of the compound in comparison to which the RR value is determined[??], wherein step d) is reiterated and in reiterated step d) CA-RR replaces the RR for each compound of one study in comparison to each other compound along each endpoint in the same study and steps e) to g) are reiterated in order to determine Summarized Comparator Adjusted EL (CA-ELₛᵤₘ), which is obtained by performing steps e) to g) upon replacing RR by CA-RR; saving the CA-ELₛᵤₘ for each compound;
i) optionally using the data obtained in a) to g) or a) to h) and ranking all compounds along the values ELₛᵤₘ or CA-ELₛᵤₘ; and
j) optionally determining a best compound for an indented pharmaceutical application, which is the compound with the best value ELₛᵤₘ or CA-ELₛᵤₘ.

39. A data carrier comprising a structure to execute a program that performs the following method:
a) constructing and displaying a Cartesian x-y coordinate-system;
b) accessing a dataset of a number of compounds stored in a data base, which dataset comprises a class of compounds and two values x and y assigned to each compound, wherein x is a first Evidence Level, and y is a second Evidence Level;
c) placing and displaying data points P(x/y) into the coordinate-system using the dataset of b), wherein each data point P(x/y) is assigned to a corresponding compound of the number of compounds in the dataset and is obtained using the x and y values assigned to the corresponding compound as x, y coordinates in the x-y coordinate-system;
d) determining a “promising rectangle” using at least one data point from the data points P(x/y) in c) and a predetermined criteria, and displaying the “promising rectangle” in the x-y coordinate-system;
e) determining a “sweet spot” using a predefined relation among the data points P(x/y) in c) and displaying the “sweet spot” in the x-y coordinate-system;
f) determining a “sweet spot circle” centered in the “sweet spot” and having a desired radius that is determined based on the data points P(x/y) in c), and displaying the “sweet spot circle” in the x-y coordinate-system;
g) optionally determining a “sweet spot circle sector” using the points P(x/y) in c), the “promising rectangle” determined in d), the “sweet spot” determined in e), and the “sweet spot circle” determined in f) and displaying the “sweet spot circle sector” in the x-y coordinate-system, wherein the “sweet spot circle sector” is an area obtained by determining a sector of the “sweet spot circle”, which is limited by 1) a first straight line drawn through the “sweet spot” and a point of a first compound with a maximum value of x, 2) a second straight line drawn through the “sweet spot” and a point of a second compound with a maximum value of y and 3) an interior of the “promising rectangle”;
h) determining an “opportunity sector” using the points P in c), the “promising rectangle” determined in d), the “sweet spot” determined in e), and the “sweet spot circle” determined in f) and displaying the “opportunity sector” in the x-y coordinate-system, wherein the “opportunity sector” is the area obtained by determining a sector of the “sweet spot circle”, which is limited by two straight lines drawn through the “sweet spot” and two data points P(x/y) so that the obtained sector does not comprise more than two data points P(x/y) and the sector is intersected by a straight line drawn through the “sweet spot” and a point M (1;1) with the Coordinates x=y=1 and is the sector closest to M(1;1);
i) inputting data points of one or more candidates compounds and placing the inputted data points into the x-y coordinate system; and
j) evaluating the one or more candidate compounds by identifying positions of their data points relative to the “promising rectangle”, the “sweet spot circle” and/or the “opportunity sector” in the x-y coordinate-system.

40. The data carrier of claim 39, wherein in the method performed by the computer system the predetermined criteria for determining said “promising rectangle” in step d) is established by determining:
d1) the point with the maximum value of x and a point with a minimum value x value;
d2) the point with the maximum value of y and a point with a minimum value of y; and
d3) drawing two straight lines in parallel to an x-axis of the x-y coordinate system through the points obtained in d1) and two straight lines in parallel to a y-axis through the points obtained in d2), thereby constructing a rectangle;
wherein the “sweet spot” is a point with the median value of x and the median value of y over all compounds obtained in c); and the radius of the “sweet spot circle” is a maximum distance of all distances between the point of the “sweet spot” and each data point P(x/y).

41. A data carrier comprising a structure to execute a program that performs the following method:
a) placing a data point for a number of compounds into a Cartesian x-y coordinate system, wherein x is a first Evidence Level and y is a second Evidence Level, each data point represents a point P(xₚ/yₚ) in the x-y coordinate system, and each xₚ and each yₚ is an Evidence Level of a compound P of the number of compounds;
b) defining a “promising rectangle” in the x-y coordinate system;
c) defining a “sweet spot” in the x-y coordinate system;
d) defining a “sweet spot circle” in the coordinate-system;
e) optionally defining a “sweet spot circle sector” in the x-y coordinate system;
f) defining an “opportunity sector” in the x-y coordinate system;
g) placing the data point for the candidate compound into the x-y coordinate system;
h) evaluating the candidate compound by identifying a position of a respective data point relative to the “promising rectangle”, the “sweet spot circle” and/or the “opportunity sector” in the x-y coordinate system; and
i) optionally performing a “realistic corridor analysis” by drawing a regression curve, drawing two parallels to the regression curve and evaluating compounds lying between limits of the two parallels and limits of the “promising rectangle”.

42. A data carrier comprising a structure to execute a program that performs the following method:
a) accessing data from a database comprising data of at least two studies, wherein in each of the at least two studies all endpoints data are assigned all compounds;
b) optionally using the data accessed in a) and comparing the data of each compound in one of the at least two studies with those of each other compound in the one of the at least studies along of all endpoints determined;
c) using the data in a) or b) and obtaining for each endpoint in a study an absolute ranking, AR, of the compounds, wherein an AR ranking of 1 is assigned to the best compound for a particular endpoint of a study, the second best compound is assigned an AR ranking of 2, the third best compound and AR ranking of 3 and saving the AR ranking of each compound and endpoint;
d) using the data obtained in a) to c) and determining a relative rank, RR, for each compound in comparison to each other compound along each endpoint in the same study, wherein for each compound an RR rank of −1 is assigned in case of inferiority, an RR rank of 0 is assigned in case of equality, and an RR rank of 1 is assigned in case of superiority as compared to the other compound in the same study; saving the RR rank for each pair of compounds;
e) using the data obtained in a) to d) and determining “Evidence Points” (EP) for each compound of one study, wherein for each compound the superior RR rank values of 1 over all endpoints are summed up to obtain the EP, which is the sum of all superior RRs for a compound in a study; saving the EP for each compound in a study;
f) using the data obtained in a) to e) and determining the “Evidence Level” (EL) for each compound of a study, wherein for each compound in a study, its EP, i.e. the number of superior endpoints of a compound, is divided by Factor A, wherein Factor A is a product of a number of endpoints multiplied with a difference of the number of compounds included in the study minus 1; saving the EL for each compound in a study;
g) using the data obtained in a) to and determining the “overall EL value (ELₛᵤₘ)” for each compound over all studies, wherein in order to obtain the ELₛᵤₘ for each compound over all studies, its EPₛᵤₘ, i.e. the sum of all EP values of a compound over all studies, is divided by the sum of factors A over all studies in which the compound is involved; saving the ELₛᵤₘ for each compound;
h) optionally using the data obtained in a) to g) and introducing a weighing factor CA, which is multiplied with the RR value of a compound in order to obtain a “Comparator Adjusted Relative Rank”, CA-RR, wherein CA of each compound is the formerly calculated Summarized Evidence Level (ELₛᵤₘ) of the compound in comparison to which the RR value is determined[??], wherein step d) is reiterated and in reiterated step d) CA-RR replaces the RR for each compound of one study in comparison to each other compound along each endpoint in the same study and steps e) to g) are reiterated in order to determine Summarized Comparator Adjusted EL (CA-ELₛᵤₘ), which is obtained by performing steps e) to g) upon replacing RR by CA-RR; saving the CA-ELₛᵤₘ for each compound;
i) optionally using the data obtained in a) to g) or a) to h) and ranking all compounds along the values ELₛᵤₘ or CA-ELₛᵤₘ; and
j) optionally determining a best compound for an indented pharmaceutical application, which is the compound with the best value ELₛᵤₘ or CA-ELₛᵤₘ.
